(19) United States
(12) Patent Application Publication
(10) Pub. No.: US 2014/0355100 A1
(43) Pub. Date: Dec. 4, 2014

(54) DISPLAY ELEMENT AND ELECTRICAL DEVICE USING THE SAME

(71) Applicant: Sharp Kabushiki Kaisha, Osaka (JP)

(72) Inventors: Toshiki Matsuoka, Osaka (JP); Tomoko Teranishi, Osaka (JP); Takuma Tomotoshi, Osaka (JP)

(73) Assignee: SHARP KABUSHIKI KAISHA, Osaka (JP)

(21) Appl. No.: 14/371,997

(22) PCT Filed: Jan. 17, 2013
(86) PCT No.: PCT/JP2013/050838

§ 371 Date: Jul. 11, 2014

(30) Foreign Application Priority Data
Jan. 18, 2012 (JP) 2012-007777

(51) Int. Cl. G02B 26/00

(52) U.S. Cl. CPC G02B 26/005
USPC 359/290

(57) ABSTRACT

A display element (2) includes an upper substrate (first substrate) (8), a lower substrate (second substrate) (9), and a polar liquid (21) that is sealed in a display space (5) formed between the upper substrate (8) and the lower substrate (9) so as to be moved toward an effective display region (P1) or a non-effective display region (P2). Each of a plurality of pixel regions (P) includes a thin film transistor (switching element) (SW) connected to a signal electrode (10) and a scanning electrode (11). In each of the pixel regions (P), a first common electrode (13) is provided on the effective display region (P1) side, and a pixel electrode (12) connected to the thin film transistor (SW) is provided on the non-effective display region (P2) side.

### TECHNICAL FIELD

The present invention relates to a display element that displays information such as images and characters by moving a polar liquid, and an electrical device using the display element.

### BACKGROUND ART

In recent years, as typified by an electrowetting type display element, a display element that displays information by utilizing a transfer phenomenon of a polar liquid due to an external electric field has been developed and put to practical use.

Specifically, in such a conventional display element, a display space is formed between first and second substrates, and the inside of the display space is divided by ribs (partitions) in accordance with a plurality of pixel regions (see, e.g., Patent Document 1). Moreover, a conductive liquid (polar liquid) is sealed in each of the pixel regions, and signal electrodes are arranged so as to cross scanning electrodes and reference electrodes that are parallel to each other. In this conventional display element, voltages are appropriately applied to the signal electrodes, the scanning electrodes, and the reference electrodes, so that the conductive liquid is moved toward the scanning electrode side or the reference electrode side in each of the pixel regions, thereby changing the display color on a display surface side.

### PRIOR ART DOCUMENTS

### Patent Documents

Patent Document 1: WO 2009/078194 A1

### DISCLOSURE OF INVENTION

### Problem to be Solved by the Invention

However, in the above conventional display element, the information is displayed by passive driving. This poses a problem that the conventional display element cannot easily improve the speed of information display.

Specifically, in the conventional display element, the signal electrodes, the scanning electrodes, and the reference electrodes are arranged in a matrix, and a scanning operation is performed to sequentially select a pair of the scanning electrode and the reference electrode as a selected line. In the selected line, a signal voltage is applied to each of the signal electrodes in sequence in accordance with the information. Therefore, the write operation of the information in the selected line will not be completed until the application of the voltage to all the signal electrodes is finished. Consequently, in the conventional display element, it is difficult to reduce the time required to perform the operation (write operation) for displaying the information per 1 frame. Thus, it has not been easy for the conventional display element to improve the speed of information display.

With the foregoing in mind, it is an object of the present invention to provide a display element that can easily improve the speed of information display, and an electrical device using the display element.

### Means for Solving Problem

To achieve the above object, a display element of the present invention includes the following: a first substrate provided on a display surface side; a second substrate provided on a non-display surface side of the first substrate so that a predetermined display space is formed between the first substrate and the second substrate; an effective display region and a non-effective display region that are defined with respect to the display space; and a polar liquid sealed in the display space so as to be moved toward the effective display region or the non-effective display region. The display element is capable of changing a display color on the display surface side by moving the polar liquid. The display element includes the following: a plurality of scanning electrodes that are provided on one of the first substrate and the second substrate so as to be electrically insulated from the polar liquid; a plurality of signal electrodes that are provided on one of the first substrate and the second substrate so as to be electrically insulated from the polar liquid and the plurality of the scanning electrodes, and are also arranged so as to intersect with the plurality of the scanning electrodes; a plurality of pixel regions that are located at each of the intersections of the plurality of the scanning electrodes and the plurality of the signal electrodes; ribs that are provided so as to divide the inside of the display space in accordance with the plurality of the pixel regions; a plurality of switching elements that are provided for each of the plurality of the pixel regions and connected to the plurality of the scanning electrodes and the plurality of the signal electrodes, respectively; a plurality of pixel electrodes that are provided on one of the first substrate and the second substrate so as to be electrically insulated from the polar liquid, the plurality of the scanning electrodes, and the plurality of the signal electrodes and to be located on one of the effective display region side and the non-effective display region side, and are also connected to the plurality of the switching elements, respectively; a plurality of first common electrodes that are provided on one of the first substrate and the second substrate so as to be electrically insulated from the polar liquid, the plurality of the scanning electrodes, the plurality of the signal electrodes, and the plurality of the pixel electrodes and to be located on the other of the effective display region side and the non-effective display region side, and are also arranged so as to intersect with the plurality of the scanning electrodes; and a second common electrode that is placed in the display space so as to be in contact with the polar liquid.

In the display element having the above configuration, the scanning electrodes and the signal electrodes are arranged in a matrix, and the pixel regions are located at each of the intersections of the scanning electrodes and the signal electrodes. The switching elements are provided in each of the pixel regions, and the scanning electrodes, the signal electrodes, and the pixel electrodes are connected to each of the switching elements. In each of the pixel regions, the pixel electrode is located on one of the effective display region side and the non-effective display region side, and the first common electrode is located on the other, and the second common electrode is placed in the display space so as to be in contact with the polar liquid. Therefore, unlike the conventional example, the display element can display information by active driving using the switching elements (active elements). Thus, unlike the conventional example, the display element can easily improve the speed of information display.

The display element preferably includes the following: a display control portion that performs drive control of each of the plurality of the scanning electrodes, the plurality of the signal electrodes, the plurality of the first common electrodes, and the second common electrodes so that a scanning operation is performed along a predetermined scanning direction based on an external image input signal; a signal voltage application portion that is connected to the plurality of the signal electrodes and the display control portion, and applies a signal voltage in a predetermined voltage range to each of the plurality of the signal electrodes in accordance with information to be displayed on the display surface side based on an instruction signal from the display control portion; a scanning voltage application portion that is connected to the plurality of the scanning electrodes and the display control portion, and applies one of an ON-state voltage and an OFF-state voltage as a scanning voltage to each of the plurality of the scanning electrodes, the ON-state voltage turning the switching elements on and allowing the signal voltage to be applied to the pixel electrodes connected to the switching elements that have been turned on, and the OFF-state voltage turning the switching elements off; a first common voltage application portion that is connected to the plurality of the first common electrodes and the display control portion, and applies a first common voltage in a predetermined voltage range, including an allowable voltage that allows the polar liquid to move in the display space in response to the signal voltage applied to the pixel electrodes, to each of the plurality of the first common electrodes; and a second common voltage application portion that is connected to the second common electrode and the display control portion, and applies a second common voltage in a predetermined voltage range, including an allowable voltage that allows the polar liquid to move in the display space in response to the signal voltage applied to the pixel electrodes, to the second common electrode.

In this case, the display control portion outputs instruction signals to the signal voltage application portion, the scanning voltage application portion, and the first and second common voltage application portions, and thus can appropriately perform the drive control of each of the scanning electrodes, the signal electrodes, and the first and second common electrodes, so that an active matrix addressed display element can be provided.

In the display element, when gradation display is performed for each of the plurality of the pixel regions on the display surface side, the display control portion may determine a value of the signal voltage in one scanning operation period for each of the plurality of the pixel regions based on the gradation display, and may indicate the determined signal voltage value to the signal voltage application portion.

In this case, the gradation display can be performed for each of the pixel regions.

In the display element, the signal voltage application portion may be configured to apply one of a maximum voltage and a minimum voltage in the predetermined voltage range as the signal voltage, and when gradation display is performed for each of the plurality of the pixel regions on the display surface side, the display control portion may determine an application time of the maximum voltage and an application time of the minimum voltage in one scanning operation period for each of the plurality of the pixel regions based on the gradation display, and may indicate the determined application times to the signal voltage application portion.

This can simplify the configuration of the signal voltage application portion.

In the display element, the signal voltage application portion may be configured to apply one of a maximum voltage, a minimum voltage, and an arbitrary voltage between the maximum voltage and the minimum voltage in the predetermined voltage range as the signal voltage, and when gradation display is performed for each of the plurality of the pixel regions on the display surface side, the display control portion may determine an application time of the maximum voltage, an application time of the arbitrary voltage, and an application time of the minimum voltage in one scanning operation period for each of the plurality of the pixel regions based on the gradation display, and may indicate the determined application times to the signal voltage application portion.

In this case, high-precision gradation display can be easily performed.

In the display element, the display control portion may instruct the signal voltage application portion and the first and second common voltage application portions to switch polarities of the corresponding signal voltage and first and second common voltages at predetermined intervals.

This can prevent uneven distribution of the polarities in each of the signal electrodes, the pixel electrodes, and the first and second common electrodes, and can easily stabilize the behavior of the polar liquid.

In the display element, the display control portion may indicate that the predetermined interval is a period of time that is shorter than one scanning operation period.

This can further prevent uneven distribution of the polarities in each of the signal electrodes, the pixel electrodes, and the first and second common electrodes, and can more easily stabilize the behavior of the polar liquid.

In the display element, the display control portion may output instruction signals to the signal voltage application portion, the scanning voltage application portion, and the first and second common voltage application portions so that a refresh operation is performed every time display of information per 1 frame is finished in order to move the polar liquid in all the plurality of the pixel regions to an initial position located on the effective display region side or the non-effective display region side.

In this case, high-precision gradation display can be easily performed.

In the display element, the plurality of the pixel regions may be provided in accordance with a plurality of colors that enable full-color display to be shown on the display surface side.

In this case, the corresponding polar liquid in each of the pixel regions can be properly moved so that the color image display can be performed.

In the display element, a dielectric layer may be formed on surfaces of the plurality of the pixel electrodes and the plurality of the first common electrodes.

In this case, the dielectric layer reliably increases the electric field applied to the polar liquid, and thus can easily improve the speed of the movement of the polar liquid.

In the display element, an insulating fluid that is not mixed with the polar liquid may be movably sealed in the display space.

This can easily improve the speed of the movement of the polar liquid.

In the display element, the non-effective display region may be defined by a light-shielding film that is provided on one of the first substrate and the second substrate, and the effective display region may be defined by an aperture formed in the light-shielding film.

In this case, the effective display region and the non-effective display region can be properly and reliably defined with respect to the display space.

An electrical device of the present invention includes a display portion that displays information including characters and images. The display portion includes any of the above display elements.

In the electrical device having the above configuration, the display portion uses the display element that can easily improve the speed of information display. Thus, a high-performance electrical device including the display portion capable of displaying information at a high speed can be easily provided.

### Effects of the Invention

The present invention can provide a display element that can easily improve the speed of information display, and an electrical device using the display element.

### BRIEF DESCRIPTION OF DRAWINGS

FIG. 1 is plan view for explaining a display element and an image display apparatus of Embodiment 1 of the present invention.

FIG. 2 is a block diagram showing the specific configuration of a display control portion shown in FIG. 1.

FIG. 3 is an enlarged plan view showing a color filter layer on an upper substrate shown in FIG. 1, when viewed from a display surface side.

FIG. 4 is an enlarged plan view showing the main configuration of the upper substrate shown in FIG. 1, when viewed from the display surface side.

FIG. 5 is an enlarged plan view showing first ribs on the upper substrate shown in FIG. 1, when viewed from the display surface side.

FIG. 6 is an enlarged plan view showing the main configuration of a lower substrate shown in FIG. 1, when viewed from a non-display surface side.

FIG. 7A is an enlarged plan view showing the main configuration in one pixel region of the display element. FIG. 7B is a cross-sectional view taken along the line VIIb-VIIb in FIG. 7A.

FIGS. 8A and 8B are cross-sectional views showing the main configuration of the display element shown in FIG. 1 during non-CF color display and CF color display, respectively.

FIGS. 9A, 9B, and 9C are diagrams showing an example of the application of a voltage to a pixel electrode, a first common electrode, and a second common electrode shown in FIG. 1, respectively.

FIGS. 10A, 10B, and 10C are diagrams showing an example of the application of a voltage to a pixel electrode, a first common electrode, and a second common electrode shown in FIG. 1 during halftone display, respectively.

FIGS. 11A, 11B, and 11C are diagrams showing an example of the application of a voltage to a pixel electrode, a first common electrode, and a second common electrode shown in FIG. 1 in a refresh operation, respectively.

FIG. 12 is a plan view for explaining a display element and an image display apparatus according to a modified example of Embodiment 1 of the present invention.

FIG. 13 is an enlarged plan view showing the main configuration of a lower substrate shown in FIG. 12, when viewed from a non-display surface side.

FIG. 14 is a block diagram showing the specific configuration of a display control portion of a display element of Embodiment 2.

FIGS. 15A, 15B, and 15C are diagrams showing an example of the application of a voltage to a pixel electrode, a first common electrode, and a second common electrode of the display element of Embodiment 2, respectively.

FIGS. 16A, 16B, and 16C are diagrams showing an example of the application of a voltage to a pixel electrode, a first common electrode, and a second common electrode of the display element of Embodiment 2 during halftone display, respectively.

FIGS. 17A, 17B, and 17C are diagrams showing an example of the application of a voltage to a pixel electrode, a first common electrode, and a second common electrode of the display element of Embodiment 2 in a refresh operation, respectively.

FIGS. 18A, 18B, and 18C are diagrams showing an example of the application of a voltage to a pixel electrode, a first common electrode, and a second common electrode of a display element according to a modified example of Embodiment 2, respectively. FIGS. 18D, 18E, and 18F are diagrams showing an example of the application of a voltage to a pixel electrode, a first common electrode, and a second common electrode of the display element according to the modified example of Embodiment 2, respectively.

FIG. 19 is a block diagram showing the specific configuration of a display control portion of a display element of Embodiment 3.

FIGS. 20A, 20B, and 20C are diagrams showing an example of the application of a voltage to a pixel electrode, a first common electrode, and a second common electrode of the display element of Embodiment 3 during halftone display, respectively.

FIG. 21 is a block diagram showing the specific configuration of a display control portion of a display element of Embodiment 4.

FIGS. 22A, 22B, and 22C are diagrams showing an example of the application of a voltage to a pixel electrode, a first common electrode, and a second common electrode of the display element of Embodiment 4 during halftone display, respectively.

FIG. 23 is a block diagram showing the specific configuration of a display control portion of a display element of Embodiment 5.

FIGS. 24A, 24B, and 24C are diagrams showing an example of the application of a voltage to a pixel electrode, a first common electrode, and a second common electrode of the display element of Embodiment 5 during halftone display, respectively.

FIG. 25 is a block diagram showing the specific configuration of a display control portion of a display element of Embodiment 6.

FIGS. 26A, 26B, and 26C are diagrams showing an example of the application of a voltage to a pixel electrode, a first common electrode, and a second common electrode of the display element of Embodiment 6 during halftone display, respectively.

### DESCRIPTION OF THE INVENTION

Hereinafter, preferred embodiments of a display element and an electrical device of the present invention will be described with reference to the drawings. In the following description, the present invention is applied to an image display apparatus including a display portion that can display color images. The size and size ratio of each of the constituent members in the drawings do not exactly reflect those of the actual constituent members.

### Embodiment 1

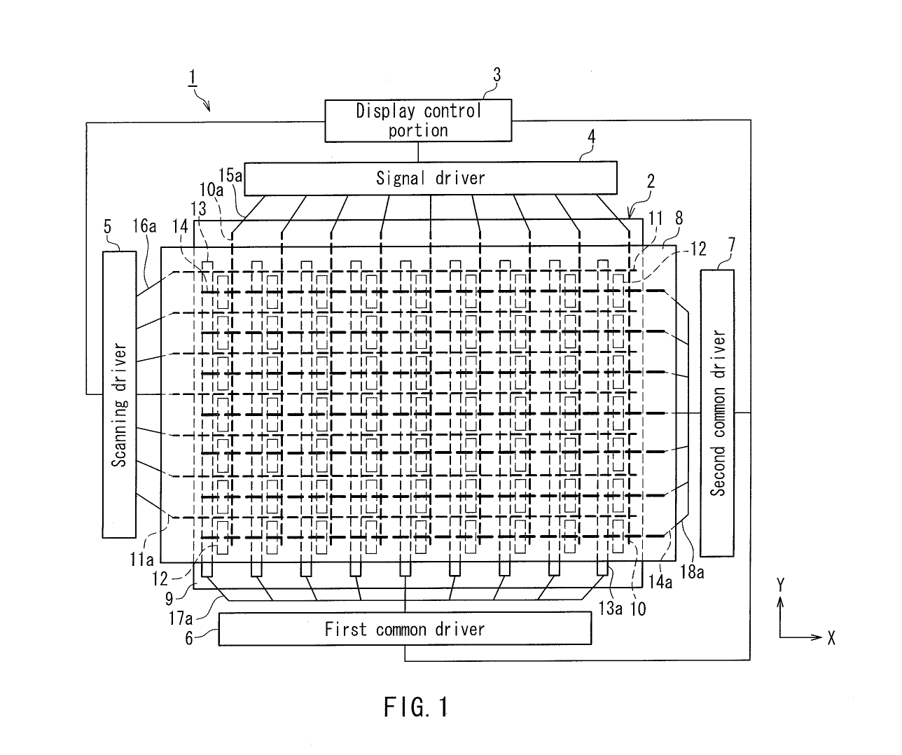

FIG. 1 is a plan view for explaining a display element and an image display apparatus of Embodiment 1 of the present invention. In FIG. 1, an image display apparatus 1 of this embodiment includes a display portion using a display element 2 of this embodiment. The display portion has a rectangular display surface. The display element 2 includes a display control portion 3, and a signal driver 4, a scanning driver 5, a first common driver 6, and a second common driver 7 that are connected to the display control portion 3. The display control portion 3 performs the drive control of each of the signal driver 4, the scanning driver 5, the first common driver 6, and the second common driver 7. In other words, the display control portion 3 is configured to receive an external image input signal, produce instruction signals for the signal driver 4, the scanning driver 5, the first common driver 6, and the second common driver 7 based on the received image input signal, and output the instruction signals to each of the drivers. This configuration allows the display element 2 to display information including characters and images in accordance with the image input signal.

The display element 2 includes an upper substrate 8 and a lower substrate 9 that are arranged to overlap each other in a direction perpendicular to the sheet of FIG. 1. The overlap between the upper substrate 8 and the lower substrate 9 forms an effective display region of the display surface (as will be described in detail later).

In the display element 2, a plurality of signal electrodes 10 are spaced at predetermined intervals and arranged in stripes in the Y direction. Moreover, in the display element 2, a plurality of scanning electrodes 11 are spaced at predetermined intervals and arranged in stripes in the X direction. The plurality of the signal electrodes 10 intersect with the plurality of the scanning electrodes 11, and a plurality of pixel regions are located at each of the intersections of the signal electrodes 10 and the scanning electrodes 11.

In the display element 2, each of the pixel regions includes a thin film transistor (TFT) SW that serves as a switching element (active element), and the signal electrode 10, the scanning electrode 11, and a pixel electrode 12 are connected to the thin film transistor SW, as will be described in detail later.

In the display element 2, a plurality of first common electrodes 13 are spaced at predetermined intervals and arranged in stripes in the Y direction. In each of the pixel regions, the first common electrode 13 is disposed to form a pair of electrodes with the corresponding pixel electrode 12 (as will be described in detail later). Moreover, in the display element 2, a plurality of second common electrodes 14 are spaced at predetermined intervals and arranged in stripes in the X direction.

Voltages in a predetermined voltage range (e.g., 18 V to 0 V) between a High voltage serving as a first voltage (referred to as “H voltage” in the following) and a Low voltage serving as a second voltage (referred to as “L voltage” in the following) can be independently applied to the signal electrodes 10, the first common electrodes 13, and the second common electrodes 14 (as will be described in detail later). An ON-state voltage that turns the thin film transistors SW on or an OFF-state voltage that turns the thin film transistors SW off can be applied to the scanning electrodes 11.

In the display element 2, the pixel regions are separated by partitions and provided for each of a plurality of colors that enable full-color display to be shown on the display surface side, as will be described in detail later. The display element 2 changes the display color on the display surface side by moving a polar liquid (as will be described later) in each of a plurality of pixels (display cells) arranged in a matrix using an electrowetting phenomenon.

Other than the above description, the pixel regions may be configured to perform monochrome display on the display surface side.

One end of the signal electrodes 10, the scanning electrodes 11, the first common electrodes 13, and the second common electrodes 14 are extended to the outside of the effective display region of the display surface and form terminals 10a, 11a, 13a, and 14a, respectively.

The signal driver 4 is connected to the individual terminals 10a of the signal electrodes 10 via wires 15a. The signal driver 4 constitutes a signal voltage application portion. When the image display apparatus 1 displays the information including characters and images on the display surface, the signal driver 4 applies a signal voltage to each of the signal electrodes 10 in accordance with the information based on the instruction signal from the display control portion 3.

The scanning driver 5 is connected to the individual terminals 11a of the scanning electrodes 11 via wires 16a. The scanning driver 5 constitutes a scanning voltage application portion. When the image display apparatus 1 displays the information including characters and images on the display surface, the scanning driver 5 applies a scanning voltage (i.e., the ON-state voltage or the OFF-state voltage) to each of the scanning electrodes 11 based on the instruction signal from the display control portion 3.

The first common driver 6 is connected to the individual terminals 13a of the first common electrodes 13 via wires 17a. The first common driver 6 constitutes a first common voltage application portion. When the image display apparatus 1 displays the information including characters and images on the display surface, the first common driver 6 applies a first common voltage to each of the first common electrodes 13 based on the instruction signal from the display control portion 3.

The second common driver 7 is connected to the individual terminals 14a of the second common electrodes 14 via wires 18a. The second common driver 7 constitutes a second common voltage application portion. When the image display apparatus 1 displays the information including characters and images on the display surface, the second common driver 7 applies a second common voltage to each of the second common electrodes 14 based on the instruction signal from the display control portion 3.

As described above, the scanning driver 5 applies one of the ON-state voltage and the OFF-state voltage as the scanning voltage to each of the scanning electrodes 11. The ON-state voltage turns the thin film transistors SW on and allows the signal voltage to be applied to the pixel electrodes 12 connected to the thin film transistors SW that have been turned on. The OFF-state voltage turns the thin film transistors SW off.

The first common driver 6 applies the first common voltage in the predetermined voltage range, including an allowable voltage that allows the polar liquid to move in response to the signal voltage applied to the pixel electrodes 12, to each of the first common electrodes 13 simultaneously. Similarly, the second driver 7 applies the second common voltage in the predetermined voltage range, including an allowable voltage that allows the polar liquid to move in response to the signal voltage applied to the pixel electrodes 12, to each of the second common electrodes 14 simultaneously.

In the display element 2, the scanning driver 5 applies the ON-state voltage to each of the scanning electrodes 11 in sequence, e.g., from the upper side to the lower side of FIG. 1, and the first and second common drivers 6, 7 apply the allowable voltage to the first and second common electrodes 13, 14 in synchronization with the operation of the scanning driver 5, respectively. Thus, the scanning operation is performed on a line-by-line basis (as will be described in detail later).

In the display element 2, the display control portion 3 outputs the instruction signals to the signal driver 4, the scanning driver 5, and the first and second common drivers 6, 7 so that a refresh operation (as will be described later) is performed every time the display of information per 1 frame is finished.

The signal driver 4, the scanning driver 5, the first common driver 6, and the second common driver 7 include, e.g., a direct-current power supply that supplies the signal voltage, the scanning voltage, the first common voltage, and the second common voltage, respectively.

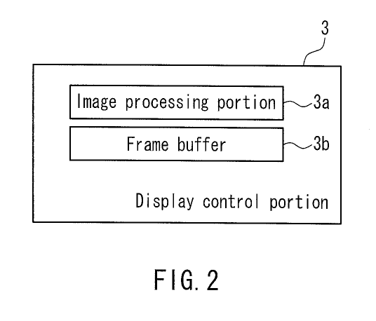

Next, the specific configuration of the display control portion 3 of this embodiment will be described with reference to FIG. 2.

FIG. 2 is a block diagram showing the specific configuration of the display control portion shown in FIG. 1.

As shown in FIG. 2, the display control portion 3 of this embodiment includes an image processing portion 3a and a frame buffer 3b. The display control portion 3 is configured to receive an image input signal from the outside of the image display apparatus 1, and perform the drive control of each of the signal electrodes 10, the scanning electrodes 11, the first common electrodes 13, and the second common electrodes 14 so that the above scanning operation is performed along the predetermined scanning direction based on the external image input signal. The image input signal includes gradation values for each of the pixel regions. When gradation display is performed for each of the pixel regions on the display surface side, the display control portion 3 determines a value of the signal voltage in one scanning operation period for each of the pixel regions based on the gradation display (i.e., the gradation values for each of the pixel regions included in the image input signal), and then indicates the determined signal voltage value to the signal driver 4.

The image processing portion 3a is configured to perform predetermined image processing on the external image input signal. Based on the results of the image processing, the image processing portion 3a produces instruction signals for the signal driver 4, the scanning driver 5, the first common driver 6, and the second common driver 7. Then, the image processing portion 3a outputs the instruction signals to the signal driver 4, the scanning driver 5, the first common driver 6, and the second common driver 7. Thus, the signal driver 4, the scanning driver 5, the first common driver 6, and the second common driver 7 output the signal voltage, the scanning voltage, the first common voltage, and the second common voltage, respectively, so that the image (information) can be displayed on the display surface in accordance with the image input signal.

The frame buffer 3b is configured to be able to store the data of the image input signal of at least 1 frame.

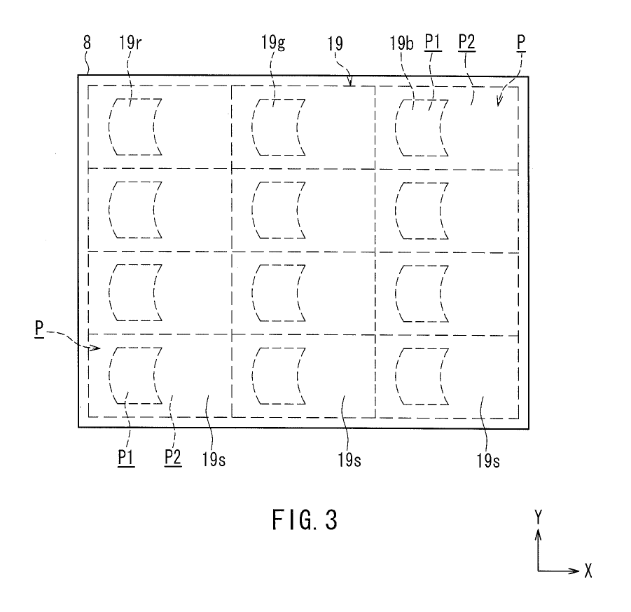

Referring also to FIGS. 3 to 8, the pixel structure of the display element 2 will be more specifically described.

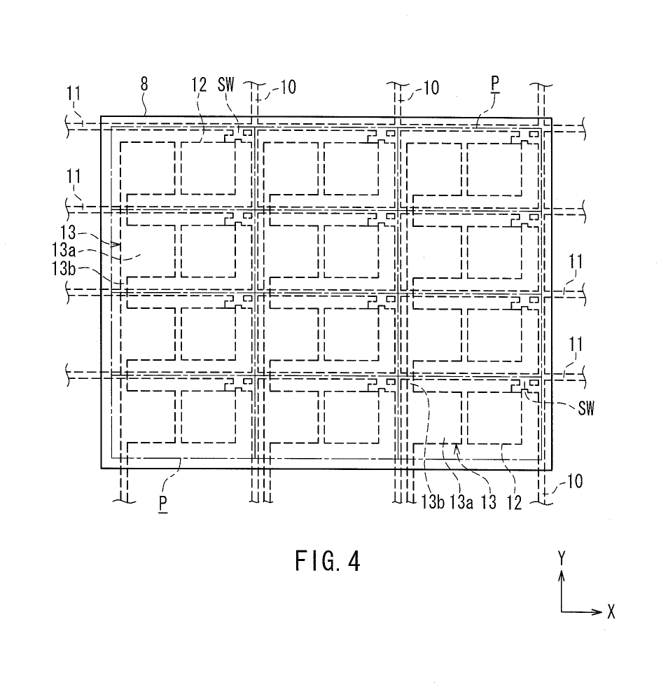

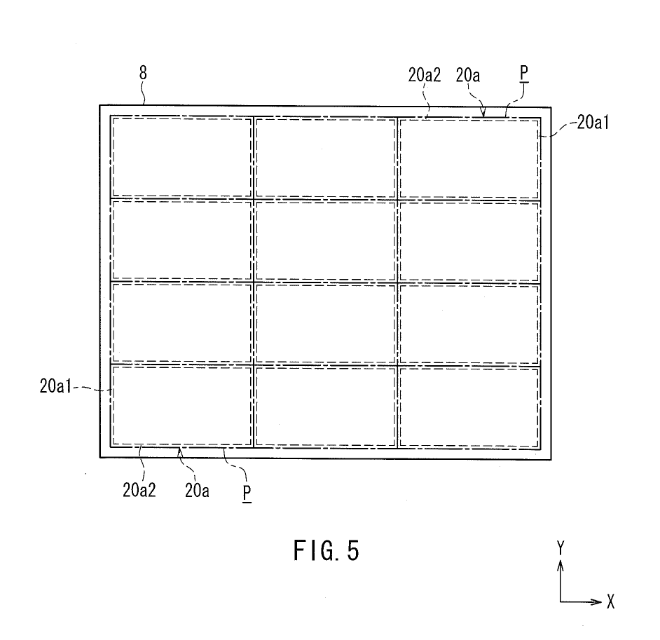

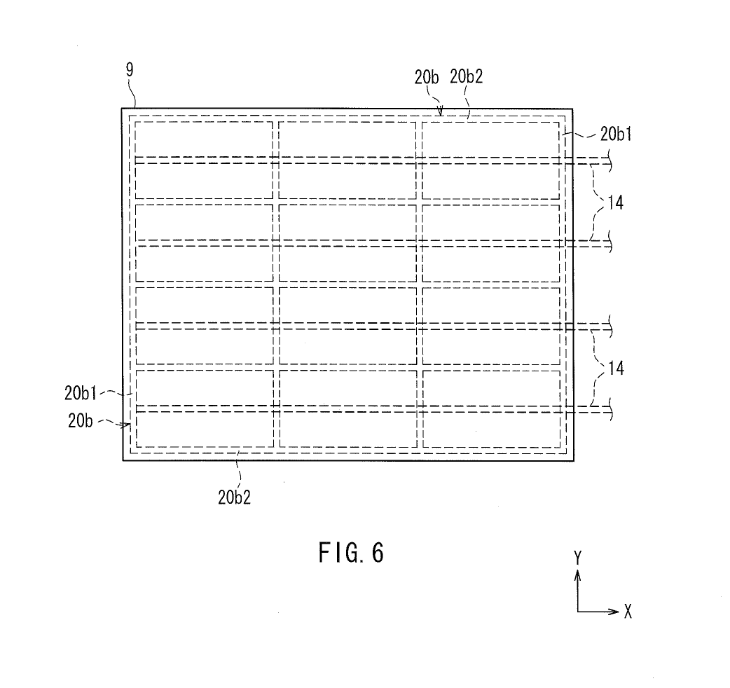

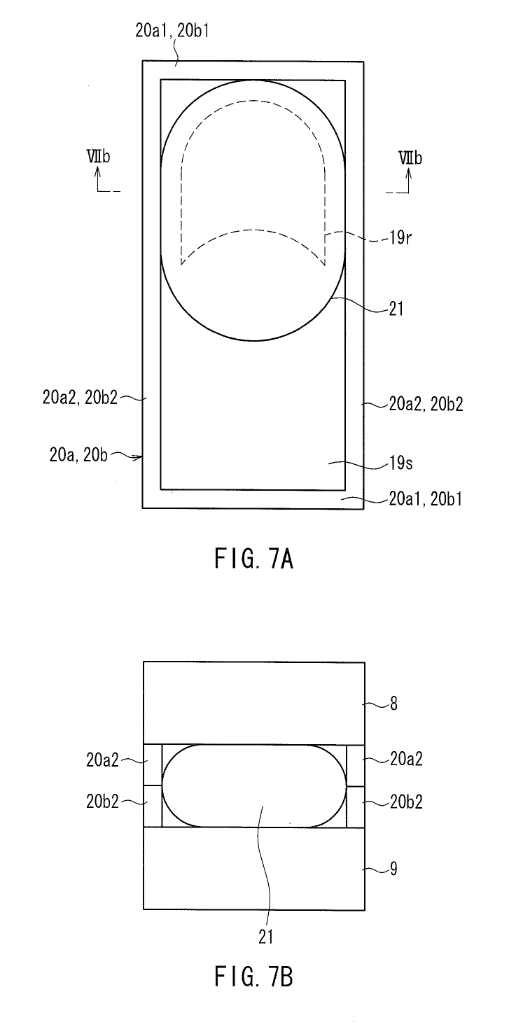

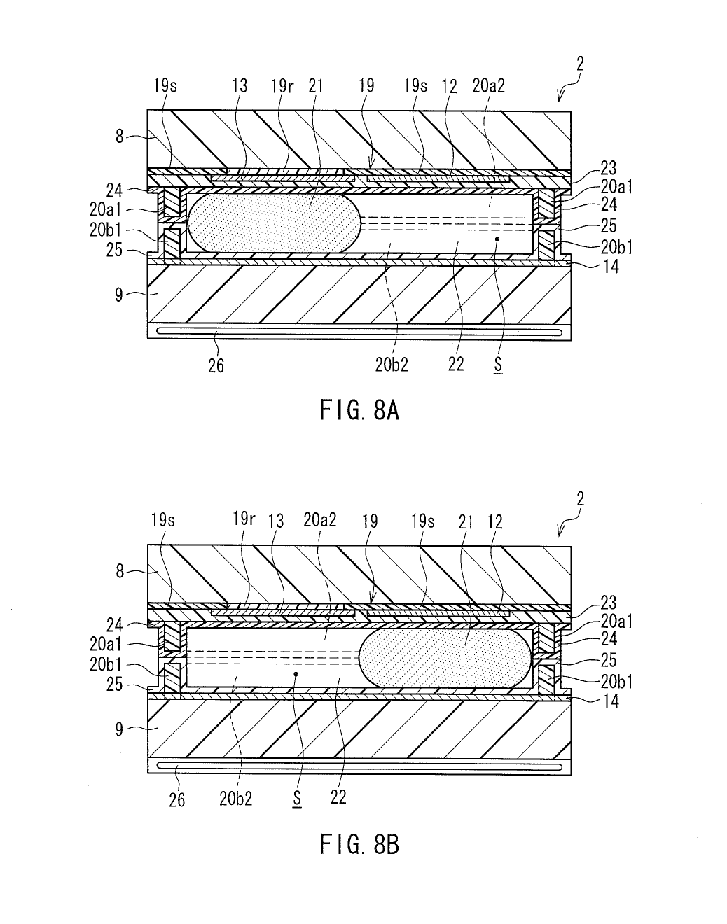

FIG. 3 is an enlarged plan view showing a color filter layer on the upper substrate shown in FIG. 1, when viewed from the display surface side. FIG. 4 is an enlarged plan view showing the main configuration of the upper substrate shown in FIG. 1, when viewed from the display surface side. FIG. 5 is an enlarged plan view showing a first rib on the upper substrate shown in FIG. 1, when viewed from the display surface side. FIG. 6 is an enlarged plan view showing the main configuration of the lower substrate shown in FIG. 1, when viewed from the non-display surface side. FIG. 7A is an enlarged plan view showing the main configuration in one pixel region of the display element. FIG. 7B is a cross-sectional view taken along the line VIIb-VIIb in FIG. 7A. FIGS. 8A and 8B are cross-sectional views showing the main configuration of the display element shown in FIG. 1 during non-CF color display and CF color display, respectively. For the sake of simplification, FIGS. 3 to 7 show twelve pixels placed at the upper left corner of the plurality of pixels on the display surface in FIG. 1. Moreover, for the sake of clarification, a color filter layer, a dielectric layer, and a hydrophobic film (as will be described later) are omitted from FIG. 7B.

In FIGS. 3 to 8, the display element 2 includes the upper substrate 8 as a first substrate that is provided on the display surface side, and the lower substrate 9 as a second substrate that is provided on the back (i.e., the non-display surface side) of the upper substrate 8. In the display element 2, the upper substrate 8 and the lower substrate 9 are located at a predetermined distance away from each other, so that a predetermined display space S is formed between the upper substrate 8 and the lower substrate 9. The polar liquid 21 and an insulating oil 22 that is not mixed with the polar liquid 21 are sealed in the display space S and can be moved in the X direction (the lateral direction of FIG. 3). The polar liquid 21 can be moved toward an effective display region P1 or a non-effective display region P2, as will be described later.

The polar liquid 21 can be, e.g., an aqueous solution including water as a solvent and a predetermined electrolyte as a solute. Specifically, 1 mmol/L of potassium chloride (KCl) aqueous solution may be used as the polar liquid 21. Moreover, the polar liquid 21 is colored a predetermined color, e.g., black with a self dispersible pigment.

The polar liquid 21 is colored black and therefore functions as a shutter that allows or prevents light transmission in each of the pixels. That is, in each of the pixels of the display element 2, the polar liquid 21 slides toward the first common electrode 13 (i.e., the effective display region P1) or the pixel electrode 12 (i.e., the non-effective display region P2) in the display space S, so that the display color is changed to black or any color of RBG, as will be described in detail later.

The oil 22 can be, e.g., a nonpolar colorless transparent oil including at least one selected from a side-chain higher alcohol, a side-chain higher fatty acid, an alkane hydrocarbon, a silicone oil, and a matching oil. The oil 22 is moved in the display space S as the polar liquid 21 slides.

The upper substrate 8 can be, e.g., a transparent glass material such as a non-alkali glass substrate or a transparent sheet material such as a transparent synthetic resin (e.g., an acrylic resin). A color filter layer 19 is formed on the surface of the upper substrate 8 that faces the non-display surface side. Moreover, the signal electrodes 10, the scanning electrodes 11, the thin film transistors SW, the pixel electrodes 12, and the first common electrodes 13 are provided on the surface of the color filter layer 19 that is on the non-display surface side of the upper substrate 8.

A dielectric layer 23 is formed to cover the signal electrodes 10, the scanning electrodes 11, the thin film transistors SW, the pixel electrodes 12, and the first common electrodes 13. Moreover, first rib members 20a1, 20a2 included in first ribs 20a are formed on the surface of the dielectric layer 23 that is on the non-display surface side of the upper substrate 8. The pixel regions P are hermetically separated from each other by the first rib members 20a1, 20a2 along with second rib members 20b1, 20b2 included in second ribs 20b (as will be described in detail later). Further, a hydrophobic film 24 is formed to cover the dielectric layer 23 and the first rib members 20a1, 20a2 on the non-display surface side of the upper substrate 8.

Like the upper substrate 8, the lower substrate 9 can be, e.g., a transparent glass material such as a non-alkali glass substrate or a transparent sheet material such as a transparent synthetic resin (e.g., an acrylic resin). The second rib members 20b1, 20b2 included in the second ribs 20b are formed on the surface of the lower substrate 9 that faces the display surface side. Moreover, the second common electrodes 14 passing through the second rib members 20b1 are provided on the surface of the lower substrate 9 that faces the display surface side. Further, a hydrophobic film 25 is formed to cover the second common electrodes 14 and the second rib members 20b1, 20b2 on the display surface side of the lower substrate 9.

A backlight 26 that emits, e.g., white illumination light is integrally attached to the back (i.e., the non-display surface side) of the lower substrate 9, thus providing a transmission type display element 2. The backlight 26 uses a light source such as a cold cathode fluorescent tube or a LED.

The color filter layer 19 includes red (R), green (G), and blue (B) color filters 19r, 19g, and 19b and a black matrix 19s serving as a light-shielding film, thereby constituting the pixels of R, G, and B colors. In the color filter layer 19, as shown in FIG. 3, the R, G, and B color filters 19r, 19g, and 19b are successively arranged in columns in the X direction, and each column includes four color filters 19r, 19g, and 19b in the Y direction. Thus, a total of twelve pixels are arranged in three columns (the X direction) and four rows (the Y direction).

As shown in FIG. 3, in each of the pixel regions P of the display element 2, any of the R, G, and B color filters 19r, 19g, and 19b is provided in a portion corresponding to the effective display region P1 of a pixel, and the black matrix 19s is provided in a portion corresponding to the non-effective display region P2 of the pixel. In other words, with respect to the display space S, the non-effective display region (non-aperture region) P2 is defined by the black matrix (light-shielding film) 19s and the effective display region P1 is defined by an aperture (which is the aperture of the light-shielding film and any of the color filters 19r, 19g, and 19b) formed in that black matrix 19s.

In the display element 2, the area of each of the color filters 19r, 19g, and 19b is the same as or slightly smaller than that of the effective display region P1. On the other hand, the area of the black matrix 19s is the same as or slightly larger than that of the non-effective display region P2. In FIG. 3, the boundary between two black matrixes 19s of adjacent pixels is indicated by a dotted line to clarify the boundary between the adjacent pixels. Actually, however, no boundary is present between the black matrixes 19s of the color filter layer 19.

In the display element 2, the display space S is hermetically divided into the pixel regions P by the first and second ribs 20a, 20b included in the partitions (ribs). Specifically, as shown in FIGS. 7A to 8B, the display space S of each pixel is partitioned by the first ribs 20a on the upper substrate 8 and the second ribs 20b on the lower substrate 9 in accordance with the pixel regions P. The first ribs 20a and the second ribs 20b are formed in contact with each other.

Specifically, the first ribs 20a include the first rib members 20a1, 20a2 that are linearly arranged parallel to the Y direction and the X direction, respectively. The first rib members 20a1, 20a2 constitute frames for the pixel regions P. Similarly, the second ribs 20b include the second rib members 20b1, 20b2 that are linearly arranged parallel to the Y direction and the X direction, respectively. The second rib members 20b1, 20b2 constitute frames for the pixel regions P. In the first ribs 20a and the second ribs 20b, the first rib members 20a1, 20a2 and the second rib members 20b1, 20b2 are formed in contact with each other via the hydrophobic films 24, 25, and thus hermetically divide the inside of the display space S in accordance with the pixel regions P. The first and second ribs 20a, 20b are made of a photo-curable resin with excellent flexibility such as an epoxy resin resist material.

The hydrophobic films 24, 25 are made of a transparent synthetic resin, and preferably a fluoropolymer that functions as a hydrophilic layer for the polar liquid 21 when a voltage is applied. This can significantly change the wettability (contact angle) between the polar liquid 21 and each of the surfaces of the upper and lower substrates 8, 9 that face the display space S. Thus, the speed of the movement of the polar liquid 21 can be improved. The dielectric layer 23 can be, e.g., a transparent dielectric film containing parylene, a silicon nitride, a hafnium oxide, a zinc oxide, a titanium dioxide, or an aluminum oxide. The presence of the dielectric layer 23 can reliably increase the electric field applied to the polar liquid 21 and easily improve the speed of the movement of the polar liquid 21.

Each of the hydrophobic films 24, 25 has a specific thickness in the range of several tens of nanometers to several micrometers. The dielectric layer 23 has a specific thickness of several hundred nanometers. The hydrophobic film 25 does not electrically insulate the second common electrodes 14 from the polar liquid 21, and therefore not interfere with the improvement in responsibility of the polar liquid 21.

The signal electrodes 10 are linear wires arranged parallel to the Y direction. The signal electrodes 10 are made of a metallic material such as gold, silver, or copper. The scanning electrodes 11 are linear wires arranged parallel to the X direction. The scanning electrodes 11 are made of a metallic material such as aluminum or copper. The signal electrodes 10 and the scanning electrodes 11 are covered with the dielectric layer 23 so as to be electrically insulated from the polar liquid 21. Moreover, the signal electrodes 10 and the scanning electrodes 11 are electrically insulated from each other at their intersections by an insulating layer (not shown).

The thin film transistors SW are provided for each of the pixel regions P, e.g., by photolithography. As shown in FIG. 4, the source electrode, the gate electrode, and the drain electrode of each of the thin film transistors SW are connected to the signal electrode 10, the scanning electrode 11, and the pixel electrode 12, respectively. When the thin film transistor SW is turned on by the ON-state voltage from the scanning electrode 11, it allows the signal voltage from the signal electrode 10 to be applied to the pixel electrode 12.

The pixel electrodes 12 are made of a transparent electrode material such as indium oxides (ITO), tin oxides (SnO₂), or zinc oxides (AZO, GZO, or IZO). The pixel electrodes 12 are provided on the color filter layer 19 in the form of a rectangle by a known film forming method such as sputtering. The pixel electrodes 12 are covered with the dielectric layer 23 so as to be electrically insulated from the polar liquid 21.

The first common electrodes 13 are made of a transparent electrode material such as indium oxides (ITO), tin oxides (SnO₂), or zinc oxides (AZO, GZO, or IZO). The first common electrodes 13 are provided on the color filter layer 19 substantially in the form of a stripe by a known film forming method such as sputtering. Specifically, as shown in FIG. 4, the first common electrodes 13 include main body portions 13a arranged in the pixel regions P and linear portions 13b for joining two adjacent main body portions 13a. The first common electrodes 13 are covered with the dielectric layer 23 so as to be electrically insulated from the polar liquid 21. The main body portions 13a have substantially the same shape as the pixel electrodes 12. Moreover, the linear portions 13b are electrically insulated from the scanning electrodes 11 by an insulating layer (not shown).

The second common electrodes 14 are linear wires arranged parallel to the X direction. The second common electrodes 14 are made of a transparent electrode material such as ITO. The second common electrodes 14 passing through the second rib members 20b1 are provided in each of the pixel regions P on the surface of the lower substrate 9 that faces the display surface side, so that the second common electrodes 14 are electrically in contact with the polar liquid 21 via the hydrophobic film 25. This can improve the responsibility of the polar liquid 21 in a display operation.

In the above description, the pixel regions P are hermetically separated from each other by the first and second ribs 20a, 20b. However, the display element 2 of this embodiment is not limited thereto, as long as the ribs are provided on the upper substrate 8 and the lower substrate 9 (at least one of the first substrate and the second substrate) so as to divide the inside of the display space S in accordance with the pixel regions P, and thus can easily prevent coalescence of the polar liquid 21 between the adjacent pixel regions P.

Specifically, e.g., the rib members may be provided on the lower substrate 9 so that there is a gap between the rib members and the surface of the upper substrate 8 that faces the non-display surface side. Alternatively, the rib members may be provided on the lower substrate 9 with the ends apart from each other to form gaps in four corners of the pixel region P.

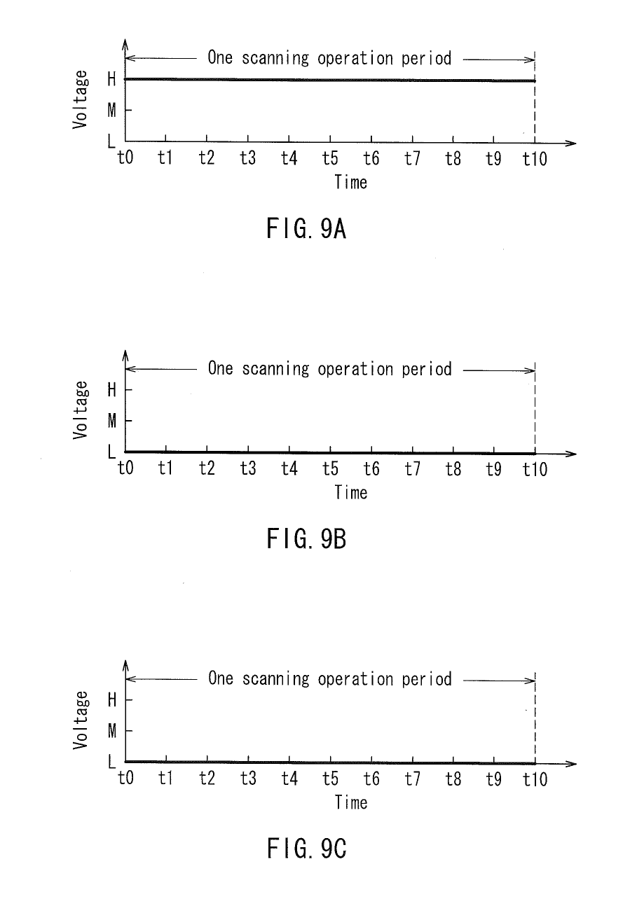

Next, referring also to FIGS. 9 to 11, a display operation of the image display apparatus 1 of this embodiment having the above configuration will be more specifically described.

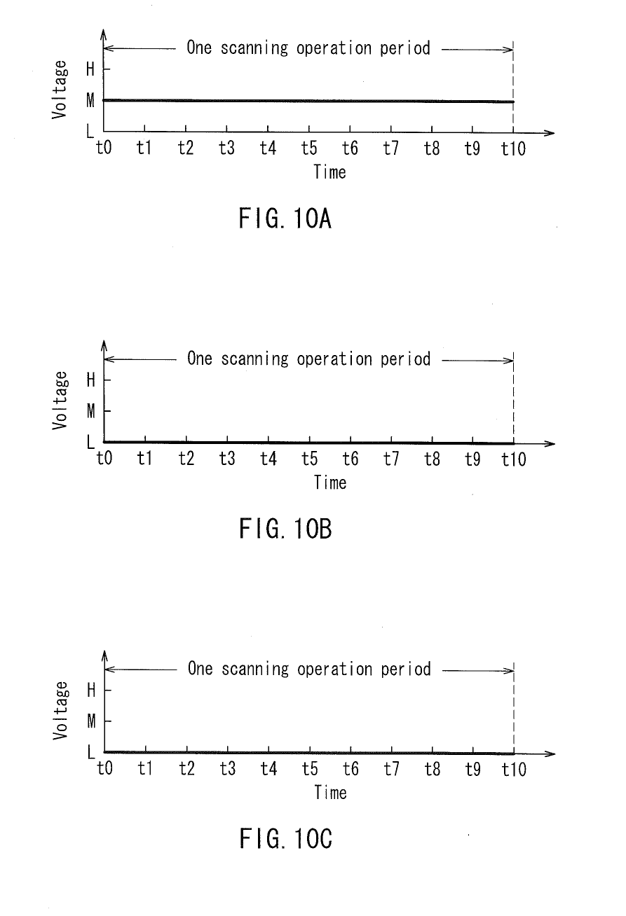

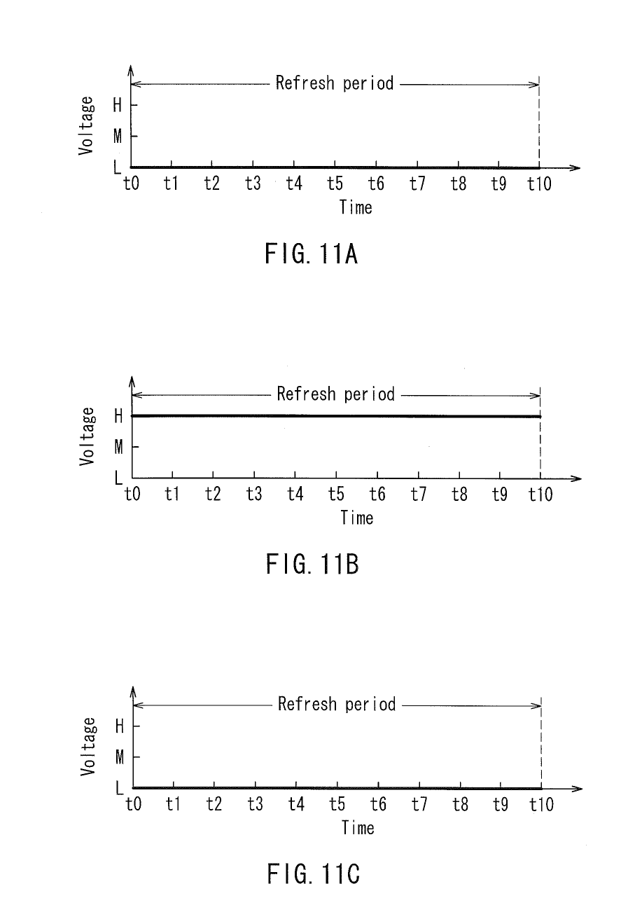

FIGS. 9A, 9B, and 9C are diagrams showing an example of the application of a voltage to a pixel electrode, a first common electrode, and a second common electrode shown in FIG. 1, respectively. FIGS. 10A, 10B, and 10C are diagrams showing an example of the application of a voltage to a pixel electrode, a first common electrode, and a second common electrode shown in FIG. 1 during halftone display, respectively. FIGS. 11A, 11B, and 11C are diagrams showing an example of the application of a voltage to a pixel electrode, a first common electrode, and a second common electrode shown in FIG. 1 in a refresh operation, respectively.

First, a basic display operation of the image display apparatus 1 of this embodiment will be described in detail with reference to FIGS. 1 and 9. The following description mainly refers to the display operation in any (one) of the pixel regions P. Here, the basic display operation means that a display operation is performed according to the maximum gradation value (e.g., “255” of 256 gray levels) or the minimum gradation value (e.g., “0” of 256 gray levels) in the gradation display (e.g., the gradation display with 256 gray levels). In the following description, the basic display operation is performed when the polar liquid 21 is completely moved to the effective display region P1 (the first common electrode 13) side by a refresh operation (as will be described later) and produces black display (non-CF color display), as shown in FIG. 8A. Moreover, in the following description, when the gradation values are a maximum value and a minimum value, the H voltage (i.e., the maximum voltage in the predetermined voltage range) and the L voltage (i.e., the minimum voltage in the predetermined voltage range) are applied to the signal electrode 10, respectively.

In FIG. 1, the scanning driver 5 applies the ON-state voltage as the scanning voltage to each of the scanning electrodes 11 in sequence in a predetermined scanning direction, e.g., from the upper side to the lower side of FIG. 1 based on the instruction signal from the display control portion 3. Thus, in the image display apparatus 1, a scanning operation (i.e., a write operation of information) is sequentially performed for each of the scanning electrodes 11 as a selected line in one frame period.

In the scanning operation, the signal driver 4 applies the H voltage (e.g., 18 V) or the L voltage (e.g., 0 V) as the signal voltage to each of the signal electrodes 10 in accordance with the information to be displayed on the display surface side based on the instruction signal from the display control portion 3. Thus, in the scanning operation, each of the thin film transistors SW connected to the corresponding scanning electrodes 11 is turned on, and then the signal voltage is applied from each of the signal electrodes 10 to the corresponding pixel electrodes 12 in accordance with the information to be displayed on the display surface side.

The first common driver 6 and the second common driver 7 apply the allowable voltage, which allows the polar liquid 21 to move in the display space S in response to the signal voltage applied to the corresponding pixel electrodes 12, to all the first common electrodes 13 and all the second common electrodes 14 based on the instruction signal from the display control portion 3 for one frame period, respectively.

Due to the above operations in the image display apparatus 1 of this embodiment, the polar liquid 21 in each of the pixel regions P can be moved in the display space S in response to the signal voltage applied to the pixel electrodes 12. In the basic display operation, the polar liquid 21 is completely moved to the effective display region P1 (the first common electrode 13) side and produces black display (non-CF color display), as shown in FIG. 8A, or the polar liquid 21 is completely moved to the non-effective display region P2 (the pixel electrode 12) side and produces red display (CF color display), as shown in FIG. 8B.

Specifically, e.g., in a pixel region P connected to the uppermost scanning electrode 11 in FIG. 1, when the ON-state voltage is applied to this scanning electrode 11, e.g., the H voltage is applied as the signal voltage from the signal electrode 10 to the pixel electrode 12 via the thin film transistor SW of the pixel region P. Consequently, as shown in FIG. 9A, the H voltage is applied to the pixel electrode 12 for one scanning operation period (the time of one scanning operation) from a time t0 to a time t10. The applied H voltage is held by the pixel electrode 12 (without being rewritten) until a new signal voltage is applied in a scanning operation of the next frame period.

On the other hand, as shown in FIGS. 9B and 9C, e.g., the L voltage is applied as the allowable voltage to the first and second common electrodes 13, 14, respectively. Consequently, the polar liquid 21 in this pixel region P is completely moved from the effective display region P1 (the first common electrode 13) side to the non-effective display region P2 (the pixel electrode 12) side, thereby producing red display (CF color display). In other words, of the pixel electrode 12 and the first common electrode 13, the polar liquid 21 in this pixel region P is moved toward the pixel electrode 12 that has a potential difference from the second common electrode 14, rather than the first common electrode 13 that does not have a potential difference from the second common electrode 14. Therefore, the polar liquid 21 has been moved to the non-effective display region P2 side, as shown in FIG. 8B, and allows the illumination light of the backlight 26 to reach the color filter 19r by shifting the oil 22 toward the first common electrode 13. Thus, the display color on the display surface side becomes red display (CF color display) due to the color filter 19r. In the image display apparatus 1, when the polar liquid 21 in three adjacent R, G, and B pixels is moved to the non-effective display region P2 side and produces CF color display, the red, green, and blue colors of light from the corresponding R, G, and B pixels are mixed into white light, resulting in white display.

On the other hand, e.g., when the L voltage is applied as the signal voltage from the signal electrode 10 to the pixel electrode 12 in the above pixel region P, the polar liquid 21 remains in the state in which it is moved to the effective display region P1 (the first common electrode 13) side due to the refresh operation. Since the L voltage is applied as the allowable voltage to the first and second common electrodes 13, 14, there is no potential difference between the pixel electrode 12 and the second common electrode 14 and also between the first common electrode 13 and the second common electrode 14. Consequently, the polar liquid 21 stands still and does not move from the effective display region P1, which is the initial position of the refresh operation (as will be described later). Therefore, as shown in FIG. 8A, the polar liquid 21 prevents the illumination light of the backlight 26 from reaching the color filter 19r. Thus, the display color on the display surface side becomes black display (non-CF color display) due to the presence of the polar liquid 21.

When the OFF-state voltage is applied as the scanning voltage to the corresponding scanning electrodes 11 in the above pixel region P, the thin film transistor SW is turned off. Consequently, no signal voltage is applied to the pixel electrode 12, and the H voltage or the L voltage that has been applied in the corresponding scanning operation is held until the end of one frame period. Therefore, the display color in this pixel region P is maintained for one frame period without changing from the black display or the CF color display in the current state.

Table 1 shows the combinations of the voltages applied to the pixel electrodes 12 (the signal electrodes 10), the first common electrodes 13, and the second common electrodes 14 in the above display operation. This display operation is performed after the refresh operation, as described above. As shown in Table 1, the behavior of the polar liquid 21 and the display color on the display surface side depend on the applied voltages. In Table 1, the H voltage and the L voltage are abbreviated to “H” and “L”, respectively (the same is true for Table 2).

TABLE 1

| First | Second | | |
|---|---|---|---|
| common | common | Pixel | |
| electrode | electrode | electrode | |
| (allowable | (allowable | (signal | Behavior of polar liquid and display |
| voltage) | voltage) | voltage) | color on display surface side |
| L | L | H | The polar liquid is moved toward the |
| | | | pixel electrode. |
| | | | CF color display |
| | | L | The polar liquid is held on the first |
| | | | common electrode side. |
| | | | Black display |

The combination of the voltages applied to the pixel electrodes 12 (the signal electrodes 10), the first common electrodes 13, and the second common electrodes 14 are not limited to Table 1, and may be as shown in Table 2. In the scanning operation, as long as the allowable voltages applied to the first and second common electrodes 13, 14 are the same value, e.g., the H voltage may be applied as the allowable voltage to both the first and second common electrodes 13, 14, as shown in Table 2. In this case, the polar liquid 21 is moved from the initial position to the pixel electrode 12 side only when the L voltage is applied to the pixel electrode 12 to make a potential difference between the pixel electrode 12 and the second common electrode 14.

TABLE 2

| First | Second | | |
|---|---|---|---|
| common | common | Pixel | |
| electrode | electrode | electrode | |
| (allowable | (allowable | (signal | Behavior of polar liquid and display |
| voltage) | voltage) | voltage) | color on display surface side |
| H | H | H | The polar liquid is held on the first |
| | | | common electrode side. |
| | | | Black display |
| | | L | The polar liquid is moved toward the |
| | | | pixel electrode. |
| | | | CF color display |

Next, referring also to FIG. 10, the following is a more detailed description of the display of halftones in the gradation display of the image display apparatus 1 of this embodiment.

The display control portion 3 determines a value of the signal voltage for each of the pixel regions P based on the external image input signal. Specifically, the image input signal includes gradation values for each of the pixel regions P, and the display control portion 3 acquires the gradation values for all the pixel regions P from the image input signal. Based on the acquired gradation values, the display control portion 3 determines a value of the signal voltage to be output from the signal driver 4 to the corresponding signal electrode 10 for each of the pixel regions P, and then outputs the instruction signal indicating the determined signal voltage value to the signal driver 4. Moreover, the display control portion 3 outputs the instruction signals to the scanning driver 5, the first common driver 6, and the second common driver 7 so that the gradation display is performed based on the external image input signal.

Specifically, e.g., when the gradation value for any one of the pixel regions P is “171”, the display control portion 3 determines a signal voltage of 12 (=171±256×18 (V)) V based on this gradation value (“171”), and then outputs the instruction signal to the signal driver 4 so that the signal voltage of 12 V is applied to the pixel electrode 12 of this pixel region P. Moreover, the display control portion 3 outputs the instruction signal to the scanning driver 5 so that a scanning operation is performed on the pixel region P, and also outputs the instruction signals to the first and second common drivers 6, 7 so that the allowable voltage is applied to the first and second common electrodes 13, 14 in synchronization with the scanning operation.

Thus, as shown in FIG. 10A, an M voltage of 12V is applied to the pixel electrode 12 for one scanning operation period (the time of one scanning operation) from a time t0 to a time t10. The applied M voltage is held by the pixel electrode 12 (without being rewritten) until a new signal voltage is applied in a scanning operation of the next frame period.

On the other hand, as shown in FIGS. 10B and 10C, e.g., the L voltage is applied as the allowable voltage to the first and second common electrodes 13, 14, respectively. Consequently, e.g., in a red pixel region P, the polar liquid 21 is moved from the effective display region P1 (the first common electrode 13) toward the non-effective display region P2 (the pixel electrode 12) by a distance corresponding to the potential difference between the pixel electrode 12 and the second common electrode 14. In other words, the polar liquid 21 is moved from the effective display region P1 (the first common electrode 13) toward the non-effective display region P2 (the pixel electrode 12) by a distance that is 0.67 (=12 V/18 V) times the distance when the H voltage (18 V), i.e., the maximum voltage is applied to the pixel electrode 12. Thus, in the red pixel region P, since a part of the color filter 19r is covered with the polar liquid 21 and the illumination light of the backlight 26 is blocked by this polar liquid 21, not full red display (CF color display), but halftone display between the full red display and black display is performed.

When the gradation values for any one of the pixel regions P are “255” and “0”, the display control portion 3 instructs that an H voltage of 18 V and an L voltage of 0 V are applied as the signal voltage, respectively. Thus, the basic display operation is performed, as described above.

Next, referring also to FIG. 11, the refresh operation in the image display apparatus 1 of this embodiment will be more specifically described.

In the image display apparatus 1 of this embodiment, the display control portion 3 outputs the instruction signals to the signal driver 4, the scanning driver 5, and the first and second common drivers 6, 7 so that the refresh operation is performed every time the display of information per 1 frame is finished in order to move the polar liquid 21 in all the pixel regions P to the initial position located, e.g., on the effective display region P1 side.

Specifically, when the display of information per 1 frame is finished, the display control portion 3 outputs the instruction signal to the signal driver 4 so that, e.g., the L voltage (0 V) is applied as the signal voltage to all the signal electrodes 10 for a predetermined refresh period (e.g., about several hundred milliseconds, which is the same time as the one scanning operation period). The display control portion 3 also outputs the instruction signal to the scanning driver 5 so that the ON-state voltage is applied as the scanning voltage to all the scanning electrodes 11 for the refresh period. Thus, in the image display apparatus 1, the thin film transistors SW in all the pixel regions P are in the on state for the refresh period. Consequently, as shown in FIG. 11A, the L voltage is applied to the pixel electrodes 12 in all the pixel regions P for the refresh period from a time t0 to a time t10. Although the time of the refresh period is set to be the same as that of the one scanning operation period, this embodiment is not limited thereto, and the refresh period may be set to be different from the one scanning operation period (the same is true for the following embodiments).

When the display of information per 1 frame is finished, the display control portion 3 outputs the instruction signal to the first common driver 6 so that, e.g., the H voltage is applied as the first common voltage to all the first common electrodes 13 for the refresh period. Moreover, when the display of information per 1 frame is finished, the display control portion 3 outputs the instruction signal to the second common driver 7 so that, e.g., the L voltage is applied as the second common voltage to all the second common electrodes 14 for the refresh period. Thus, as shown in FIGS. 11B and 11C, the H voltage and the L voltage are applied to the first and second common electrodes 13, 14 for the refresh period, respectively. Consequently, of the pixel electrode 12 and the first common electrode 13, the polar liquid 21 in all the pixel regions P is completely moved toward the first common electrode 13 (the effective display region P1) that has a potential difference from the second common electrode 14, and is stopped at the initial position located on the effective display region P1 side, where the polar liquid 21 has been moved completely.

Other than the above description, the display control portion 3 may output the instruction signals to the signal driver 4, the first common driver 6, and the second common driver 7 so that, e.g., the H voltage, the L voltage, and the H voltage are applied to all the signal electrodes 10 (all the pixel electrodes 12), all the first common electrodes 13, and all the second common electrodes 14 for the refresh period, respectively.

Other than the above description, the refresh operation may be performed to move the polar liquid 21 in all the pixel regions P to the initial position located on the non-effective display region P2 side (where the polar liquid 21 has been completely moved to the pixel electrode 12 side).

In the display element 2 of this embodiment having the above configuration, the scanning electrodes 11 and the signal electrodes 10 are arranged in a matrix, and the pixel regions P are located at each of the intersections of the scanning electrodes 11 and the signal electrodes 10. The thin film transistors (switching elements) SW are provided in each of the pixel regions P, and the scanning electrodes 11, the signal electrodes 10, and the pixel electrodes 12 are connected to each of the thin film transistors SW. In each of the pixel regions P, the pixel electrode 12 and the first common electrode 13 are located on the non-effective display region P2 side and the effective display region P1 side, respectively, and the second common electrode 14 is placed in the display space S so as to be in contact with the polar liquid 21. Therefore, unlike the conventional example, the display element 2 of this embodiment can display information by active driving using the thin film transistors SW (active elements). Thus, unlike the conventional example, the display element 2 of this embodiment can easily improve the speed of information display.

In the image display apparatus (electrical device) 1 of this embodiment, the display portion uses the display element 2 that can easily improve the speed of information display. Thus, it is easy to provide a high-performance image display apparatus 1 that includes the display portion capable of displaying the information at a high speed.

The display element 2 of this embodiment includes the display control portion 3, and the signal driver (signal voltage application portion) 4, the scanning driver (scanning voltage application portion) 5, the first common driver (first common voltage application portion) 6, and the second common driver (second common voltage application portion) 7 that are connected to the display control portion 3. In this embodiment, therefore, the display control portion 3 outputs the instruction signals to the signal driver 4, the scanning driver 5, the first common driver 6, and the second common driver 7, and thus can appropriately perform the drive control of each of the signal electrodes 10, the scanning electrodes 11, the first common electrodes 13, and the second common electrodes 14, so that an active matrix addressed display element 2 can be provided.

In the display element 2 of this embodiment, when the gradation display is performed for each of the pixel regions P on the display surface side, the display control portion 3 determines a value of the signal voltage in one scanning operation period for each of the pixel regions P based on the gradation display, and then indicates the determined signal voltage value to the signal driver 4. Thus, the display element 2 of this embodiment can perform the gradation display for each of the pixel regions P.

In the display element 2 of this embodiment, the display control portion 3 outputs the instruction signals to the signal driver 4, the scanning driver 5, and the first and second common drivers 6, 7 so that the refresh operation is performed every time the display of information per 1 frame is finished in order to move the polar liquid 21 in all the pixel regions P to the initial position located on the effective display region P1 side. Thus, the display element 2 of this embodiment can align the polar liquid 21 in all the pixel regions P at the initial position every time the display of information per 1 frame is finished, and can easily perform high-precision gradation display.

### Modified Example of Embodiment 1

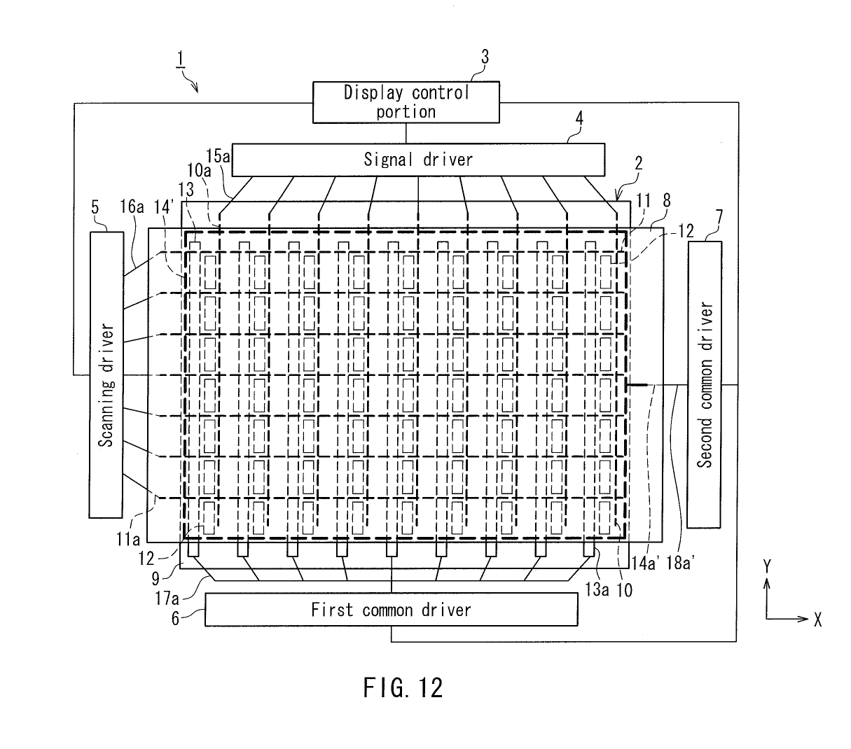

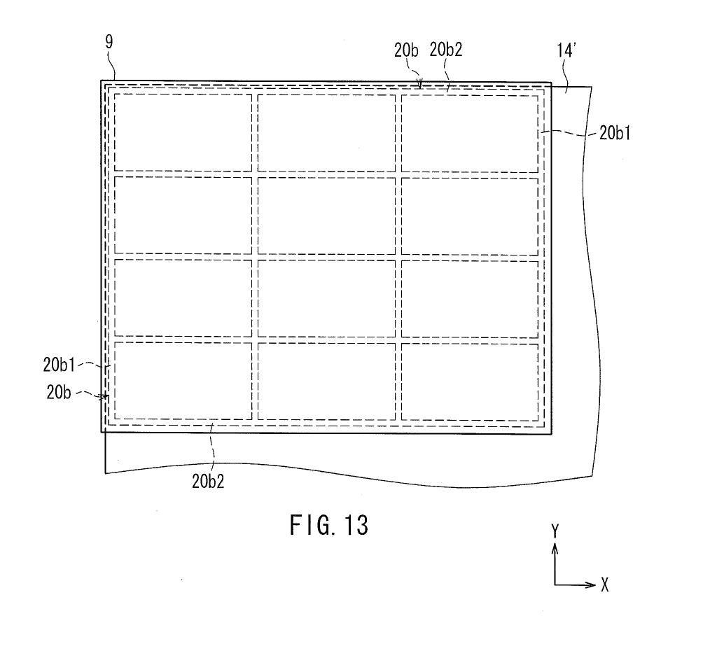

FIG. 12 is a plan view for explaining a display element and an image display apparatus according to a modified example of Embodiment 1 of the present invention. FIG. 13 is an enlarged plan view showing the main configuration of a lower substrate shown in FIG. 12, when viewed from the non-display surface side.

In FIGS. 12 and 13, this embodiment mainly differs from Embodiment 1 in that the second common electrode is formed of a planar electrode. The same components as those of Embodiment 1 are denoted by the same reference numerals, and the explanation will not be repeated.

As shown in FIGS. 12 and 13, the display element 2 of this embodiment includes a planar second common electrode 14′ provided on the surface of the lower substrate 9 that faces the display surface side. The second common electrode 14′ is in contact with the polar liquid 21 in each of the pixel regions P. The second common driver 7 is connected to a terminal 14a′ of the second common electrodes 14′ via a wire 18a′. In the display element 2 of this embodiment, unlike Embodiment 1, the second ribs 20b including the second rib members 20b1, 20b2 are formed on the surface of the second common electrode 14′ that faces the display surface side.

With the above configuration, this embodiment can have the same effects as those of Embodiment 1.

### Embodiment 2

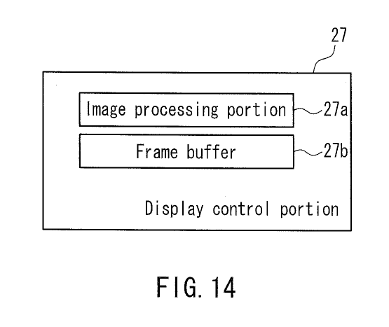

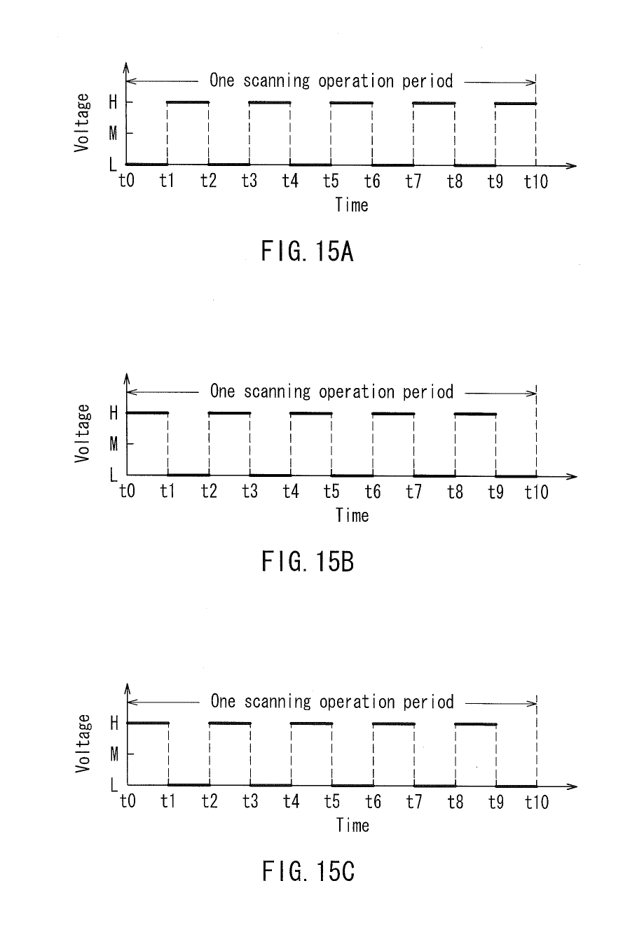

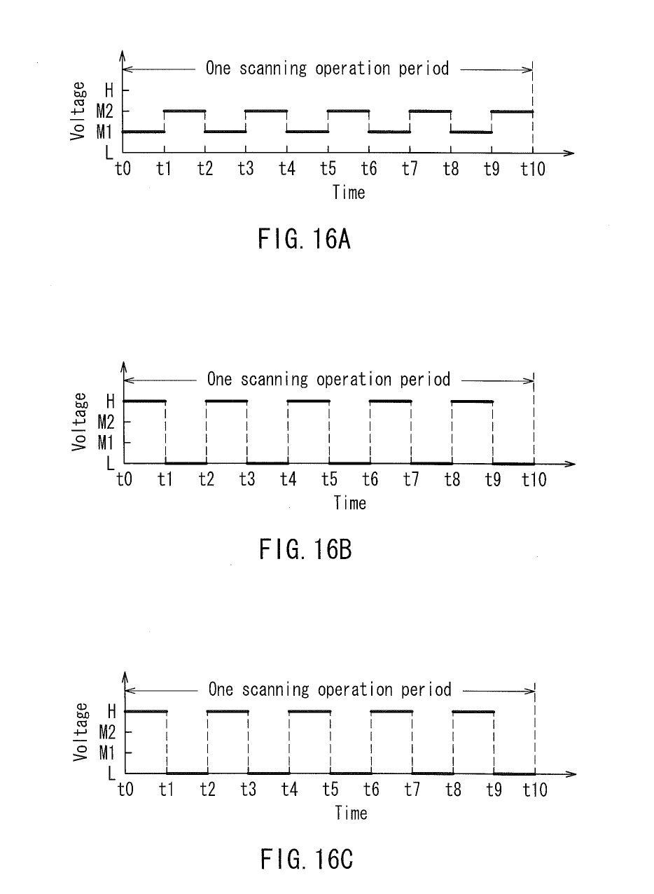

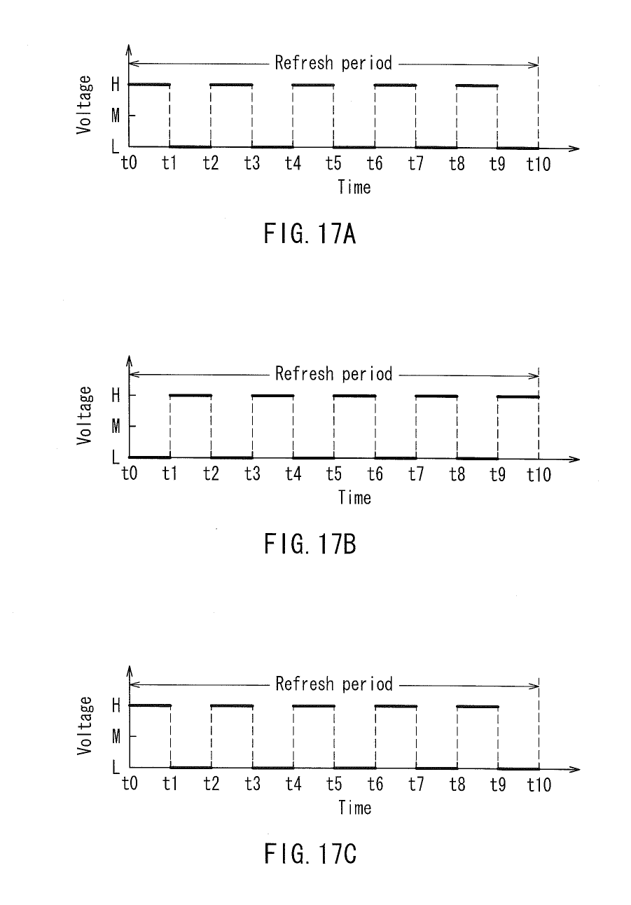

FIG. 14 is a block diagram showing the specific configuration of a display control portion of a display element of Embodiment 2. FIGS. 15A, 15B, and 15C are diagrams showing an example of the application of a voltage to a pixel electrode, a first common electrode, and a second common electrode of the display element of Embodiment 2, respectively. FIGS. 16A, 16B, and 16C are diagrams showing an example of the application of a voltage to a pixel electrode, a first common electrode, and a second common electrode of the display element of Embodiment 2 during halftone display, respectively. FIGS. 17A, 17B, and 17C are diagrams showing an example of the application of a voltage to a pixel electrode, a first common electrode, and a second common electrode of the display element of Embodiment 2 in a refresh operation, respectively.

In FIGS. 14 to 17, this embodiment mainly differs from Embodiment 1 in that the display control portion allows the polarities of the signal voltage and the first and second common voltages to be switched at intervals of a predetermined time which is shorter than one scanning operation period. The same components as those of Embodiment 1 are denoted by the same reference numerals, and the explanation will not be repeated.

In FIG. 14, similarly to Embodiment 1, the display element 2 of this embodiment includes a display control portion 27 that includes an image processing portion 27a and a frame buffer 27b. However, unlike Embodiment 1, the display control portion 27 outputs the instruction signals to the signal driver 4 and the first and second common drivers 6, 7 so that the polarities of the signal voltage and the first and second common voltages are switched at intervals of a predetermined time which is shorter than the scanning operation period (refresh period).

Specifically, the image processing portion 27a of the display control portion 27 outputs the instruction signal to the signal driver 4 so that the polarities of the signal voltage are switched, e.g., at intervals of one-tenth of the one scanning operation period. Thus, as shown in FIG. 15A, the L voltage is applied from the signal electrode 10 to the pixel electrode 12 in any one of the pixel regions P for the period from a time t0 to a time t1. Then, the H voltage is applied to the pixel electrode 12 for the period from the time t1 to a time t2, followed by the L voltage for the period from the time t2 to a time t3. Subsequently, the H voltage is applied to the pixel electrode 12 for the period from the time t3 to a time t4, followed by the L voltage for the period from the time t4 to a time t5. Subsequently, the H voltage is applied to the pixel electrode 12 for the period from the time t5 to a time t6, followed by the L voltage for the period from the time t6 to a time t7. Subsequently, the H voltage is applied to the pixel electrode 12 for the period from the time t7 to a time t8, followed by the L voltage for the period from the time t8 to a time t9. Thereafter, the H voltage is applied to the pixel electrode 12 for the period from the time t9 to a time t10.

The image processing portion 27a of the display control portion 27 outputs the instruction signal to the first common driver 6 so that the polarities of the first common voltage are switched at intervals of one-tenth of the one scanning operation period. Thus, as shown in FIG. 15B, the H voltage is applied to the first common electrode 13 for the period from a time t0 to a time t1. Then, the L voltage is applied to the first common electrode 13 for the period from the time t1 to a time t2, followed by the H voltage for the period from the time t2 to a time t3. Subsequently, the L voltage is applied to the first common electrode 13 for the period from the time t3 to a time t4, followed by the H voltage for the period from the time t4 to a time t5. Subsequently, the L voltage is applied to the first common electrode 13 for the period from the time t5 to a time t6, followed by the H voltage for the period from the time t6 to a time t7. Subsequently, the L voltage is applied to the first common electrode 13 for the period from the time t7 to a time t8, followed by the H voltage for the period from the time t8 to a time t9. Thereafter, the L voltage is applied to the first common electrode 13 for the period from the time t9 to a time t10.

The image processing portion 27a of the display control portion 27 outputs the instruction signal to the second common driver 7 so that the polarities of the second common voltage are switched at intervals of one-tenth of the one scanning operation period. Thus, as shown in FIG. 15C, the H voltage is applied to the second common electrode 14 for the period from a time t0 to a time t1. Then, the L voltage is applied to the second common electrode 14 for the period from the time t1 to a time t2, followed by the H voltage for the period from the time t2 to a time t3. Subsequently, the L voltage is applied to the second common electrode 14 for the period from the time t3 to a time t4, followed by the H voltage for the period from the time t4 to a time t5. Subsequently, the L voltage is applied to the second common electrode 14 for the period from the time t5 to a time t6, followed by the H voltage for the period from the time t6 to a time t7. Subsequently, the L voltage is applied to the second common electrode 14 for the period from the time t7 to a time t8, followed by the H voltage for the period from the time t8 to a time t9. Thereafter, the L voltage is applied to the second common electrode 14 for the period from the time t9 to a time t10.

As described above, in all the intervals from the time t0 to the time t10 of the one scanning operation period shown in FIGS. 11A to 11C, of the pixel electrode 12 and the first common electrode 13, the voltage is applied to make a potential difference between the pixel electrode 12 and the second common electrode 14. Therefore, as in the one scanning operation period shown in FIGS. 9A to 9C, the polar liquid 21 in this pixel region P is completely moved to the pixel electrode 12 (the non-effective display region P2) side and produces red display (CF color display) due to the color filter 19r.

When the image display apparatus 1 of this embodiment displays halftones in the gradation display, similarly to Embodiment 1, the display control portion 27 determines a value of the signal voltage for each of the pixel regions P based on the external image input signal. Moreover, the display control portion 27 of this embodiment determines a value of the signal voltage in each interval in view of the predetermined interval (i.e., the period of time in which the polarities of the signal voltage and the first and second common voltages are switched).

Specifically, e.g., when the gradation value for any one of the pixel regions P is “128”, the display control portion 27 determines a signal voltage of 9 (=128±256×18 (V)) V based on this gradation value (“128”). Moreover, in view of the fact that the polarities are switched at intervals of one-tenth of the one scanning operation period, the display control portion 27 determines a signal voltage of 6 V for the period during which the H voltage (18 V) being applied to the first and second common electrodes 13, 14 and a signal voltage of 12 V for the period during which the L voltage (0 V) being applied to the first and second common electrodes 13, 14. Then, the display control portion 27 outputs the instruction signal to the signal driver 4 so that signal voltages of 6 V and 12 V are applied to the pixel electrode 12 of this pixel region P at predetermined intervals.

Thus, as shown in FIG. 16A, the M1 voltage (6 V) is applied from the signal electrode 10 to the pixel electrode 12 in any one of the pixel regions P for the period from a time t0 to a time t1. Then, the M2 voltage (12 V) is applied to the pixel electrode 12 for the period from the time t1 to a time t2, followed by the M1 voltage for the period from the time t2 to a time t3. Subsequently, the M2 voltage is applied to the pixel electrode 12 for the period from the time t3 to a time t4, followed by the M1 voltage for the period from the time t4 to a time t5. Subsequently, the M2 voltage is applied to the pixel electrode 12 for the period from the time t5 to a time t6, followed by the M1 voltage for the period from the time t6 to a time t7. Subsequently, the M2 voltage is applied to the pixel electrode 12 for the period from the time t7 to a time t8, followed by the M1 voltage for the period from the time t8 to a time t9. Thereafter, the M2 voltage is applied to the pixel electrode 12 for the period from the time t9 to a time t10.

The image processing portion 27a of the display control portion 27 outputs the instruction signal to the first common driver 6 so that the polarities of the first common voltage are switched at intervals of one-tenth of the one scanning operation period. Thus, as shown in FIG. 16B, the H voltage is applied to the first common electrode 13 for the period from a time t0 to a time t1. Then, the L voltage is applied to the first common electrode 13 for the period from the time t1 to a time t2, followed by the H voltage for the period from the time t2 to a time t3. Subsequently, the L voltage is applied to the first common electrode 13 for the period from the time t3 to a time t4, followed by the H voltage for the period from the time t4 to a time t5. Subsequently, the L voltage is applied to the first common electrode 13 for the period from the time t5 to a time t6, followed by the H voltage for the period from the time t6 to a time t7. Subsequently, the L voltage is applied to the first common electrode 13 for the period from the time t7 to a time t8, followed by the H voltage for the period from the time t8 to a time t9. Thereafter, the L voltage is applied to the first common electrode 13 for the period from the time t9 to a time t10.

The image processing portion 27a of the display control portion 27 outputs the instruction signal to the second common driver 7 so that the polarities of the second common voltage are switched at intervals of one-tenth of the one scanning operation period. Thus, as shown in FIG. 16C, the H voltage is applied to the second common electrode 14 for the period from a time t0 to a time t1. Then, the L voltage is applied to the second common electrode 14 for the period from the time t1 to a time t2, followed by the H voltage for the period from the time t2 to a time t3. Subsequently, the L voltage is applied to the second common electrode 14 for the period from the time t3 to a time t4, followed by the H voltage for the period from the time t4 to a time t5. Subsequently, the L voltage is applied to the second common electrode 14 for the period from the time t5 to a time t6, followed by the H voltage for the period from the time t6 to a time t7. Subsequently, the L voltage is applied to the second common electrode 14 for the period from the time t7 to a time t8, followed by the H voltage for the period from the time t8 to a time t9. Thereafter, the L voltage is applied to the second common electrode 14 for the period from the time t9 to a time t10.

Due to the above voltage application, the halftone display with a gradation value of “128” is performed. For one half of the one scanning operation period, the voltage is applied to make a potential difference of 12 V (=18 V−6 V) between the pixel electrode 12 and the second common electrode 14. For the other half of the one scanning operation period, the voltage is applied to make a potential difference of 6 V (=18 V−12 V) between the pixel electrode 12 and the second common electrode 14. Consequently, the polar liquid 21 is moved toward the pixel electrode 12 (the non-effective display region P2) by a distance that is 0.5 (=12/18×1/2+6/18×1/2) times, and thus the gradation display is performed according to the gradation value “128” (which is 0.5 times the 256 gray levels) in this pixel region P.

In the above description, as the signal voltage, the M1 voltage and the M2 voltage are alternately applied at intervals. However, this embodiment is not limited thereto, as long as the signal voltage to be applied at intervals is determined in view of a gradation value and the period of time in which the polarities are switched so that the gradation display is performed according to the gradation value.

In the image display apparatus 1 of this embodiment, when a refresh operation is performed during the gradation display, the display control portion 27 outputs the instruction signals to the signal driver 4 and the first and second common drivers 6, 7 so that the polarities of the signal voltage and the first and second common voltages are switched at intervals of the predetermined intervals.

Specifically, the image processing portion 27a of the display control portion 27 outputs the instruction signal to the signal driver 4 so that the polarities of the signal voltage are switched, e.g., at intervals of one-tenth of the refresh period (one scanning operation period). Thus, as shown in FIG. 17A, the H voltage is applied from the signal electrode 10 to the pixel electrode 12 in any one of the pixel regions P for the period from a time t0 to a time t1. Then, the L voltage is applied to the pixel electrode 12 for the period from the time t1 to a time t2, followed by the H voltage for the period from the time t2 to a time t3. Subsequently, the L voltage is applied to the pixel electrode 12 for the period from the time t3 to a time t4, followed by the H voltage for the period from the time t4 to a time t5. Subsequently, the L voltage is applied to the pixel electrode 12 for the period from the time t5 to a time t6, followed by the H voltage for the period from the time t6 to a time t7. Subsequently, the L voltage is applied to the pixel electrode 12 for the period from the time t7 to a time t8, followed by the H voltage for the period from the time t8 to a time t9. Thereafter, the L voltage is applied to the pixel electrode 12 for the period from the time t9 to a time t10.

The image processing portion 27a of the display control portion 27 outputs the instruction signal to the first common driver 6 so that the polarities of the first common voltage are switched at intervals of one-tenth of the refresh period. Thus, as shown in FIG. 17B, the L voltage is applied to the first common electrode 13 for the period from a time t0 to a time t1. Then, the H voltage is applied to the first common electrode 13 for the period from the time t1 to a time t2, followed by the L voltage for the period from the time t2 to a time t3. Subsequently, the H voltage is applied to the first common electrode 13 for the period from the time t3 to a time t4, followed by the L voltage for the period from the time t4 to a time t5. Subsequently, the H voltage is applied to the first common electrode 13 for the period from the time t5 to a time t6, followed by the L voltage for the period from the time t6 to a time t7. Subsequently, the H voltage is applied to the first common electrode 13 for the period from the time t7 to a time t8, followed by the L voltage for the period from the time t8 to a time t9. Thereafter, the H voltage is applied to the first common electrode 13 for the period from the time t9 to a time t10.

The image processing portion 27a of the display control portion 27 outputs the instruction signal to the second common driver 7 so that the polarities of the second common voltage are switched at intervals of one-tenth of the refresh period. Thus, as shown in FIG. 17C, the H voltage is applied to the second common electrode 14 for the period from a time t0 to a time t1. Then, the L voltage is applied to the second common electrode 14 for the period from the time t1 to a time t2, followed by the H voltage for the period from the time t2 to a time t3. Subsequently, the L voltage is applied to the second common electrode 14 for the period from the time t3 to a time t4, followed by the H voltage for the period from the time t4 to a time t5. Subsequently, the L voltage is applied to the second common electrode 14 for the period from the time t5 to a time t6, followed by the H voltage for the period from the time t6 to a time t7. Subsequently, the L voltage is applied to the second common electrode 14 for the period from the time t7 to a time t8, followed by the H voltage for the period from the time t8 to a time t9. Thereafter, the L voltage is applied to the second common electrode 14 for the period from the time t9 to a time t10.

As described above, in all the intervals from the time t0 to the time t10 of the refresh period shown in FIGS. 17A to 17C, of the pixel electrode 12 and the first common electrode 13, the voltage is applied to make a potential difference between the first common electrode 13 and the second common electrode 14. Therefore, as in the refresh period shown in FIGS. 11A to 11C, the polar liquid 21 in all the pixel regions P is moved to the initial position on the first common electrode 13 (the effective display region P1) side.

With the above configuration, this embodiment can have the same effects as those of Embodiment 1. In this embodiment, the display control portion 27 instructs the signal driver 4 and the first and second common drivers 6, 7 to switch the polarities of the signal voltage and the first and second common voltages at predetermined intervals, respectively. Thus, this embodiment can prevent uneven distribution of the polarities in each of the signal electrodes 10, the pixel electrodes 12, and the first and second common electrodes 13, 14, and can easily stabilize the behavior of the polar liquid 21.

In this embodiment, the display control portion 27 indicates that the predetermined interval is the period of time that is shorter than the one scanning operation period. Thus, this embodiment can further prevent uneven distribution of the polarities in each of the signal electrodes 10, the pixel electrodes 12, and the first and second common electrodes 13, 14, and can more easily stabilize the behavior of the polar liquid 21.

### Modified Example of Embodiment 2

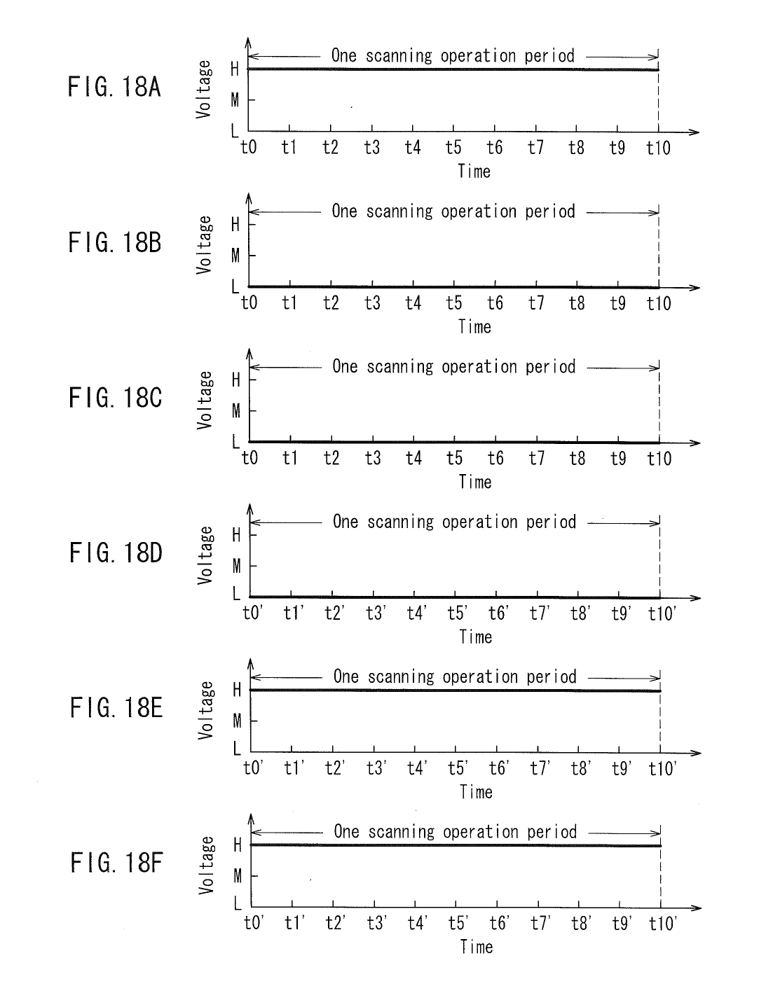

FIGS. 18A, 18B, and 18C are diagrams showing an example of the application of a voltage to a pixel electrode, a first common electrode, and a second common electrode of a display element according to a modified example of Embodiment 2, respectively. FIGS. 18D, 18E, and 18F are diagrams showing an example of the application of a voltage to a pixel electrode, a first common electrode, and a second common electrode of the display element according to the modified example of Embodiment 2, respectively.

In FIG. 18, this embodiment mainly differs from Embodiment 2 in that the display control portion allows the polarities of the signal voltage, the selected voltage, and the non-selected voltage to be switched at intervals of one scanning operation period. The same components as those of Embodiment 2 are denoted by the same reference numerals, and the explanation will not be repeated.

As shown in FIGS. 18A to 18F, in this modified example, the instruction signals are output to the signal driver 4 and the first and second common drivers 6, 7 so that the polarities of the signal voltage and the first and second common voltages are switched at intervals of one scanning operation period.

Specifically, as shown in FIGS. 18A to 18C, the H voltage, the L voltage, and the L voltage are applied to the pixel electrode 12, the first common electrode 13, and the second common electrode 14 for one scanning operation period from a time t0 to a time t10, respectively. Then, after the refresh operation has been performed, as shown in FIGS. 18D to 18F, the L voltage, the H voltage, and the H voltage (as a result of switching the polarities) are applied to the pixel electrode 12, the first common electrode 13, and the second common electrode 14 for one scanning operation period from a time t0′ to a time t10′ after the above one scanning operation period, respectively.

With the above configuration, this embodiment can have the same effects as those of Embodiment 2.

### Embodiment 31

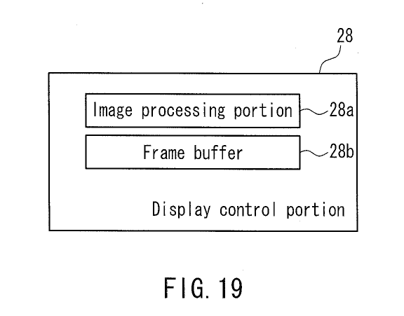

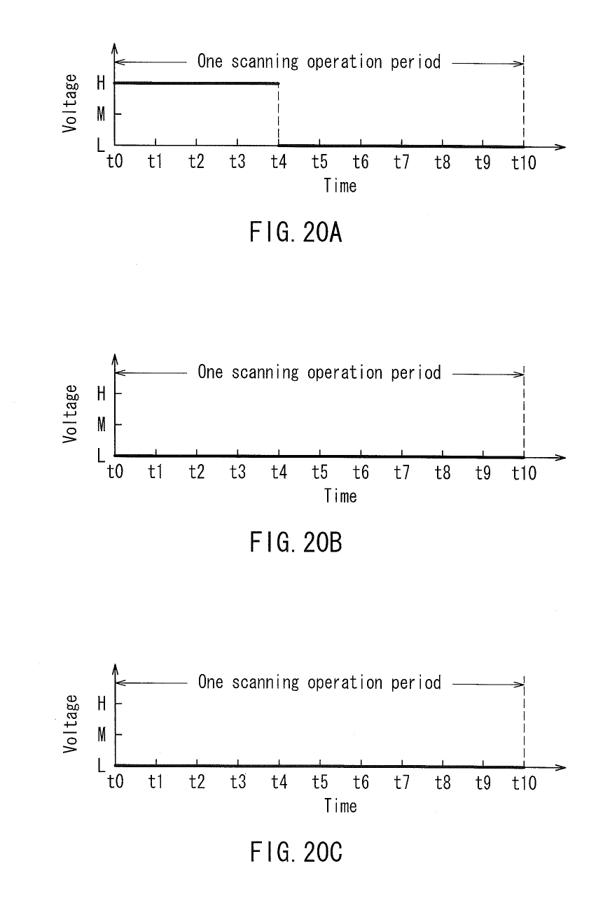

FIG. 19 is a block diagram showing the specific configuration of a display control portion of a display element of Embodiment 3. FIGS. 20A, 20B, and 20C are diagrams showing an example of the application of a voltage to a pixel electrode, a first common electrode, and a second common electrode of the display element of Embodiment 3 during halftone display, respectively.

In FIGS. 19 and 20, this embodiment mainly differs from Embodiment 1 in that when the gradation display is performed for each of the pixel regions on the display surface side, the display control portion indicates an application time of the maximum voltage and an application time of the minimum voltage in one scanning operation period for each of the pixel regions based on the gradation display to the signal voltage application portion. The same components as those of Embodiment 1 are denoted by the same reference numerals, and the explanation will not be repeated.

In FIG. 19, similarly to Embodiment 1, the display element 2 of this embodiment includes a display control portion 28 that includes an image processing portion 28a and a frame buffer 28b. However, unlike Embodiment 1, when the gradation display is performed for each of the pixel regions P on the display surface side, the display control portion 28 indicates an application time of the maximum voltage (H voltage) and an application time of the minimum voltage (L voltage) in one scanning operation period for each of the pixel regions P based on the gradation display to the signal driver 4. In the display element 2 of this embodiment, the signal driver 4 applies one of the maximum voltage and the minimum voltage in the predetermined voltage range as the signal voltage.

Specifically, e.g., when the gradation value for any one of the pixel regions P is “102”, the display control portion 28 determines the application time of the maximum voltage and the application time of the minimum voltage in one scanning operation period based on this gradation value (“102”). As the application time of the H voltage, the display control portion 28 calculates a time of one scanning operation period×4/10 from the formula represented by one scanning operation period×102/256. As the application time of the L voltage, the display control portion 28 calculates the remainder after subtracting the application time of the H voltage from the one scanning operation period, i.e., a time of one scanning operation period×6/10. Then, the display control portion 28 instructs the signal driver 4 to apply the H voltage as the signal voltage for the time of one scanning operation period×4/10 as the application time of the H voltage (maximum voltage), and also to apply the L voltage as the signal voltage for the time of one scanning operation period×6/10 as the application time of the L voltage (minimum voltage).

Thus, as shown in FIG. 20A, the H voltage is applied to the pixel electrode 12 for the period from a time t0 to a time t4, followed by the L voltage for the period from the time t4 to a time t10. As shown in FIGS. 20B and 20C, similarly to Embodiment 1 shown in FIGS. 10B and 10C, the L voltage is applied to both the first common electrode 13 and the second common electrode 14, respectively.

Due to the above voltage application, the halftone display with a gradation value of “102” is performed. For four-tenths of the one scanning operation period, the voltage is applied to make a potential difference of 18 V (H voltage) between the pixel electrode 12 and the second common electrode 14. For the remaining six-tenths of the one scanning operation period, the voltage is applied to make a potential difference of 0 V between the pixel electrode 12 and the second common electrode 14. Consequently, the polar liquid 21 is moved toward the pixel electrode 12 (the non-effective display region P2) by a distance that is 0.4 (=4/10) times, and thus the gradation display is performed according to the gradation value “102” (which is 0.4 times the 256 gray levels) in this pixel region P.

In the above description, as shown in FIG. 20A, the application time of the H voltage is set from the start of one scanning operation period, and the application time of the L voltage is the remainder of the one scanning operation period. However, this embodiment is not limited thereto. For example, the application time of the L voltage may be set from the start of one scanning operation period, and the application time of the H voltage may be the remainder of the one scanning operation period. Alternatively, a plurality of the application times of the H voltage and a plurality of the application times of the L voltage may be set so that the H voltage and the L voltage are applied alternately. Specifically, in this embodiment, e.g., when the gradation display with a gradation value of “n” (e.g., n is an integer of 0 to 255) is performed, the application time of the H voltage may be n/256×one scanning operation period, and the application time of the L voltage may be the remainder of the one scanning operation period.

With the above configuration, this embodiment can have the same effects as those of Embodiment 1. In this embodiment, the signal driver 4 applies one of the maximum voltage and the minimum voltage in the predetermined voltage range as the signal voltage. Moreover, when the gradation display is performed for each of the display regions P on the display surface side, the display control portion 28 determines the application time of the maximum voltage and the application time of the minimum voltage in one scanning operation period for each of the pixel regions P based on the gradation display, and then indicates the determined application times to the signal driver 4. Thus, this embodiment can simplify the configuration of the signal driver 4.

### Embodiment 4

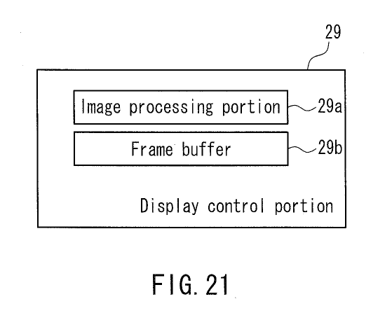

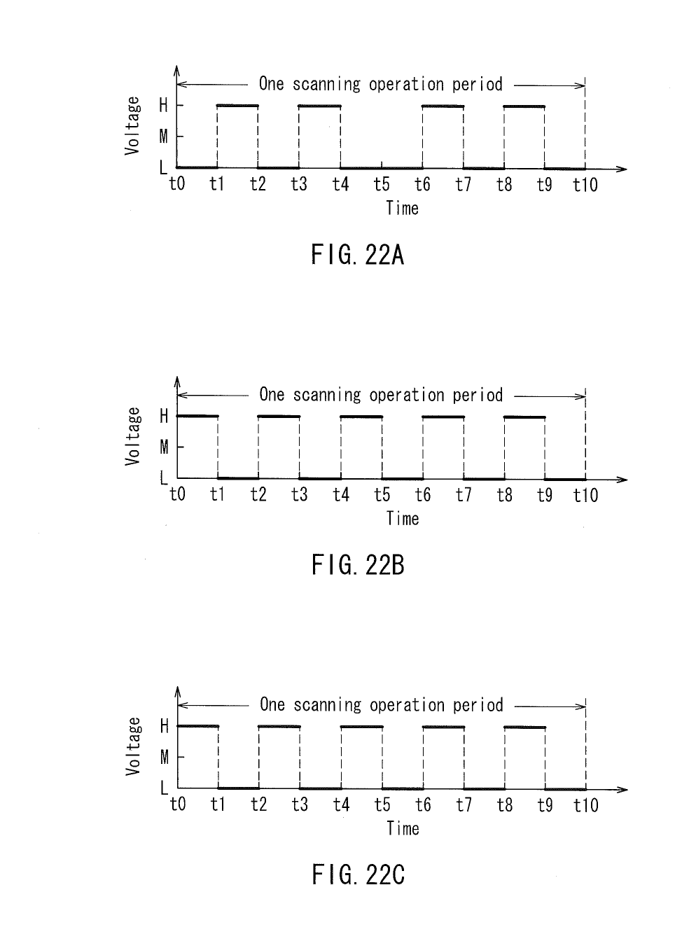

FIG. 21 is a block diagram showing the specific configuration of a display control portion of a display element of Embodiment 4. FIGS. 22A, 22B, and 22C are diagrams showing an example of the application of a voltage to a pixel electrode, a first common electrode, and a second common electrode of the display element of Embodiment 4 during halftone display, respectively.

In FIGS. 21 and 22, this embodiment mainly differs from Embodiment 3 in that the display control portion allows the polarities of the signal voltage and the first and second common voltages to be switched at intervals of a predetermined time which is shorter than one scanning operation period. The same components as those of Embodiment 3 are denoted by the same reference numerals, and the explanation will not be repeated.

In FIG. 21, similarly to Embodiment 3, the display element 2 of this embodiment includes a display control portion 29 that includes an image processing portion 29a and a frame buffer 29b. However, unlike Embodiment 3, the display control portion 29 outputs the instruction signals to the signal driver 4 and the first and second common drivers 6, 7 so that the polarities of the signal voltage and the first and second common voltages are switched at intervals of a predetermined time which is shorter than the scanning operation period (refresh period). In the display element 2 of this embodiment, similarly to Embodiment 3, the signal driver 4 applies one of the maximum voltage (H voltage) and the minimum voltage (L voltage) in the predetermined voltage range as the signal voltage.

When the image display apparatus 1 of this embodiment displays halftones in the gradation display, similarly to Embodiment 3, the display control portion 29 determines the application time of the maximum voltage and the application time of the minimum voltage in one scanning operation period for each of the pixel regions P based on the external image input signal, and then indicates the determined application times to the signal driver 4. Moreover, the display control portion 29 of this embodiment determines the application time of the H voltage and the application time of the L voltage in view of the predetermined interval (i.e., the period of time in which the polarities of the signal voltage and the first and second common voltages are switched).

Specifically, e.g., when the gradation value for any one of the pixel regions P is “128”, based on this gradation value (“128”) and in view of the fact that the polarities are switched at intervals of one-tenth of the one scanning operation period, the display control portion 29 determines that the application time of the H voltage (18 V) is five-tenths of the one scanning operation period and the application time of the L voltage (0 V) is five-tenths of the one scanning operation period. Then, the display control portion 29 outputs the instruction signal to the signal driver 4 so that signal voltages of 18 V and 0 V are applied to the pixel electrode 12 of this pixel region P at predetermined intervals.

Thus, as shown in FIG. 22A, the L voltage is applied from the signal electrode 10 to the pixel electrode 12 in any one of the pixel regions P for the period from a time t0 to a time t1. Then, the H voltage is applied to the pixel electrode 12 for the period from the time t1 to a time t2, followed by the L voltage for the period from the time t2 to a time t3. Subsequently, the H voltage is applied to the pixel electrode 12 for the period from the time t3 to a time t4, followed by the L voltage for the period from the time t4 to a time t5. Subsequently, the L voltage is applied to the pixel electrode 12 for the period from the time t5 to a time t6, followed by the H voltage for the period from the time t6 to a time t7. Subsequently, the L voltage is applied to the pixel electrode 12 for the period from the time t7 to a time t8, followed by the H voltage for the period from the time t8 to a time t9. Thereafter, the L voltage is applied to the pixel electrode 12 for the period from the time t9 to a time t10.

The image processing portion 29a of the display control portion 29 outputs the instruction signal to the first common driver 6 so that the polarities of the first common voltage are switched at intervals of one-tenth of the one scanning operation period. Thus, as shown in FIG. 22B, the H voltage is applied to the first common electrode 13 for the period from a time t0 to a time t1. Then, the L voltage is applied to the first common electrode 13 for the period from the time t1 to a time t2, followed by the H voltage for the period from the time t2 to a time t3. Subsequently, the L voltage is applied to the first common electrode 13 for the period from the time t3 to a time t4, followed by the H voltage for the period from the time t4 to a time t5. Subsequently, the L voltage is applied to the first common electrode 13 for the period from the time t5 to a time t6, followed by the H voltage for the period from the time t6 to a time t7. Subsequently, the L voltage is applied to the first common electrode 13 for the period from the time t7 to a time t8, followed by the H voltage for the period from the time t8 to a time t9. Thereafter, the L voltage is applied to the first common electrode 13 for the period from the time t9 to a time t10.

The image processing portion 29a of the display control portion 29 outputs the instruction signal to the second common driver 7 so that the polarities of the second common voltage are switched at intervals of one-tenth of the one scanning operation period. Thus, as shown in FIG. 22C, the H voltage is applied to the second common electrode 14 for the period from a time t0 to a time t1. Then, the L voltage is applied to the second common electrode 14 for the period from the time t1 to a time t2, followed by the H voltage for the period from the time t2 to a time t3. Subsequently, the L voltage is applied to the second common electrode 14 for the period from the time t3 to a time t4, followed by the H voltage for the period from the time t4 to a time t5. Subsequently, the L voltage is applied to the second common electrode 14 for the period from the time t5 to a time t6, followed by the H voltage for the period from the time t6 to a time t7. Subsequently, the L voltage is applied to the second common electrode 14 for the period from the time t7 to a time t8, followed by the H voltage for the period from the time t8 to a time t9. Thereafter, the L voltage is applied to the second common electrode 14 for the period from the time t9 to a time t10.

Due to the above voltage application, the halftone display with a gradation value of “128” is performed. For one half of the one scanning operation period (i.e., the period from the time t0 to the time t5), the voltage is applied to make a potential difference of 18 V (H voltage) between the pixel electrode 12 and the second common electrode 14. For the other half of the one scanning operation period (i.e., the period from the time t5 to the time t10), the voltage is applied to make a potential difference of 0 V between the pixel electrode 12 and the second common electrode 14. Consequently, the polar liquid 21 is moved toward the pixel electrode 12 (the non-effective display region P2) by a distance that is 0.5 times, and thus the gradation display is performed according to the gradation value “128” (which is 0.5 times the 256 gray levels) in this pixel region P.

In the above description, the predetermined interval is the period of time that is one-tenth of the one scanning operation period. However, this embodiment is not limited thereto, as long as the application time of the H voltage and the application time of the L voltage are determined according to the gradation value, and the H voltage and the L voltage are applied alternately. Specifically, in this embodiment, e.g., when the gradation display with a gradation value of “n” (e.g., n is an integer of 0 to 255) is performed, provided that the predetermined interval is period of time that is obtained by multiplying the one scanning operation period by 1/256, the application time of the H voltage may be n/256×one scanning operation period, and the application time of the L voltage may be the remainder of the one scanning operation period.

With the above configuration, this embodiment can have the same effects as those of Embodiment 3. In this embodiment, the display control portion 29 instructs the signal driver 4 and the first and second common drivers 6, 7 to switch the polarities of the signal voltage and the first and second common voltages at predetermined intervals, respectively. Thus, this embodiment can prevent uneven distribution of the polarities in each of the signal electrodes 10, the pixel electrodes 12, and the first and second common electrodes 13, 14, and can easily stabilize the behavior of the polar liquid 21.

In this embodiment, the display control portion 29 indicates that the predetermined interval is the period of time that is shorter than the one scanning operation period. Thus, this embodiment can further prevent uneven distribution of the polarities in each of the signal electrodes 10, the pixel electrodes 12, and the first and second common electrodes 13, 14, and can more easily stabilize the behavior of the polar liquid 21.

### Embodiment 5

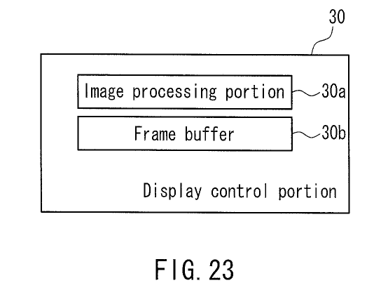

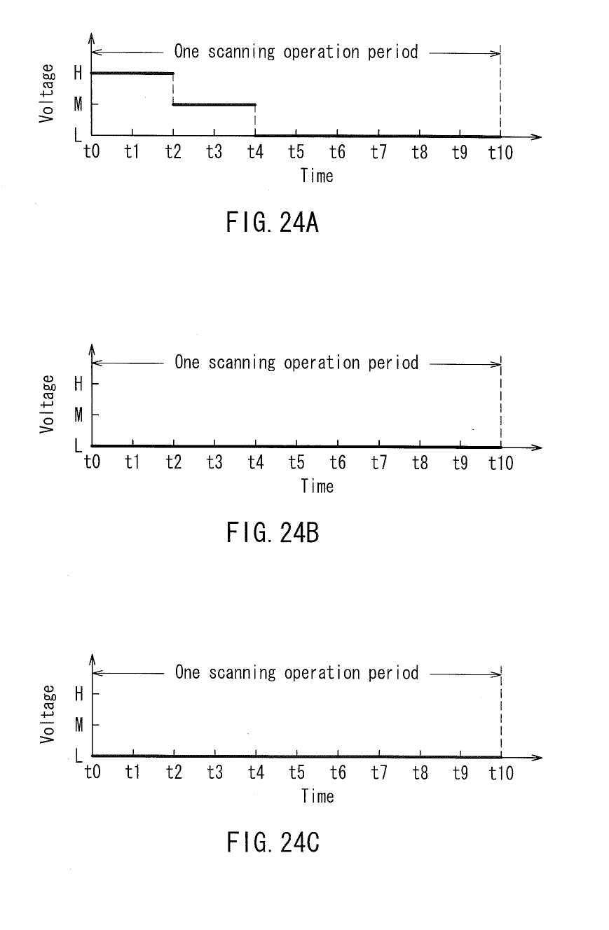

FIG. 23 is a block diagram showing the specific configuration of a display control portion of a display element of Embodiment 5. FIGS. 24A, 24B, and 24C are diagrams showing an example of the application of a voltage to a pixel electrode, a first common electrode, and a second common electrode of the display element of Embodiment 5 during halftone display, respectively.

In FIGS. 23 and 24, this embodiment mainly differs from Embodiment 1 in that when the gradation display is performed for each of the pixel regions on the display surface side, the display control portion indicates an application time of the maximum voltage, an application time of the minimum voltage application time, and an application time of an arbitrary voltage between the maximum voltage and the minimum voltage in one scanning operation period for each of the pixel regions based on the gradation display to the signal voltage application portion. The same components as those of Embodiment 1 are denoted by the same reference numerals, and the explanation will not be repeated.

In FIG. 23, similarly to Embodiment 1, the display element 2 of this embodiment includes a display control portion 30 that includes an image processing portion 30a and a frame buffer 30b. However, unlike Embodiment 1, when the gradation display is performed for each of the pixel regions P on the display surface side, the display control portion 30 indicates the application time of the maximum voltage (H voltage), the application time of the minimum voltage (L voltage) application time, and an application time of an arbitrary voltage between the maximum voltage and the minimum voltage in one scanning operation period for each of the pixel regions P based on the gradation display to the signal driver 4. In the display element 2 of this embodiment, the signal driver 4 applies one of the maximum voltage, the minimum voltage, and the arbitrary voltage between the maximum voltage and the minimum voltage in the predetermined voltage range as the signal voltage.

Specifically, e.g., when the gradation value for any one of the pixel regions P is “77”, the display control portion 30 determines the application time of the maximum voltage application time, the application time of the minimum voltage application time, and the application time of the arbitrary voltage in one scanning operation period based on this gradation value (“77”). As the application time of the H voltage, the display control portion 30 calculates a time of one scanning operation period×2/10. As the application time of the L voltage, the display control portion 30 calculates a time of one scanning operation period×6/10. Moreover, the display control portion 30 determines, e.g., the arbitrary voltage of 9V and calculates a time of one scanning operation period×2/10 as the application time of the arbitrary voltage. Then, the display control portion 30 instructs the signal driver 4 to apply the H voltage as the signal voltage for the time of one scanning operation period×2/10 as the application time of the H voltage (maximum voltage), to apply 9V (arbitrary voltage) as the signal voltage for the time of one scanning operation period×2/10 as the application time of the arbitrary voltage, and also to apply the L voltage as the signal voltage for the time of one scanning operation period×6/10 as the application time of the L voltage (minimum voltage).

Thus, as shown in FIG. 24A, the H voltage is applied to the pixel electrode 12 for the period from a time t0 to a time t2, followed by the M voltage (arbitrary voltage), which is 9V, for the period from the time t2 to a time t4, and further followed by the L voltage for the period from the time t4 to a time t10. As shown in FIGS. 24B and 24C, similarly to Embodiment 1 shown in FIGS. 10B and 10C, the L voltage is applied to both the first common electrode 13 and the second common electrode 14, respectively.

Due to the above voltage application, the halftone display with a gradation value of “77” is performed. For two-tenths of the one scanning operation period (i.e., the period from the time t0 to the time t2), the voltage is applied to make a potential difference of 18 V (H voltage) between the pixel electrode 12 and the second common electrode 14. For two-tenths of the one scanning operation period (i.e., the period from the time t2 to the time t4), the voltage is applied to make a potential difference of 9 V (=18−9) between the pixel electrode 12 and the second common electrode 14. For the remaining six-tenths of the one scanning operation period (i.e., the period from the time t4 to the time t10), the voltage is applied to make a potential difference of 0 V between the pixel electrode 12 and the second common electrode 14. Consequently, the polar liquid 21 is moved toward the pixel electrode 12 (the non-effective display region P2) by a distance that is 0.3 (=2/10+9/18×2/10) times, and thus the gradation display is performed according to the gradation value “77” (which is 0.3 times the 256 gray levels) in this pixel region P.

In the above description, as shown in FIG. 24A, the application time of the H voltage is set from the start of one scanning operation period, and the application time of the arbitrary voltage and the application time of the L voltage are the remainder of the one scanning operation period. However, this embodiment is not limited thereto. For example, the application time of the L voltage may be set from the start of one scanning operation period, and the application time of the H voltage and the application time of the arbitrary voltage may be the remainder of the one scanning operation period. Alternatively, a plurality of the application times of the H voltage, a plurality of the application times of the arbitrary voltage, and a plurality of the application times of the L voltage may be set so that the H voltage, the arbitrary voltage, and the L voltage are applied sequentially. Moreover, it is also possible to determine a plurality of types of arbitrary voltages and application times of each of the arbitrary voltages.

With the above configuration, this embodiment can have the same effects as those of Embodiment 1. In this embodiment, the signal driver 4 applies one of the maximum voltage, the minimum voltage, and the arbitrary voltage between the maximum voltage and the minimum voltage in the predetermined voltage range as the signal voltage. Moreover, when the gradation display is performed for each of the pixel regions P on the display surface side, the display control portion 30 determines the application time of the maximum voltage, the application time of the arbitrary voltage, and the application time of the minimum voltage in one scanning operation period for each of the pixel regions P based on the gradation display, and then indicates the determined application times to the signal driver 4. Thus, this embodiment can easily perform high-precision gradation display.

### Embodiment 6

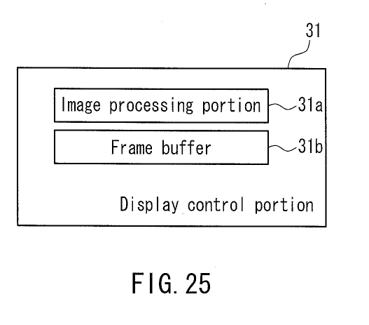

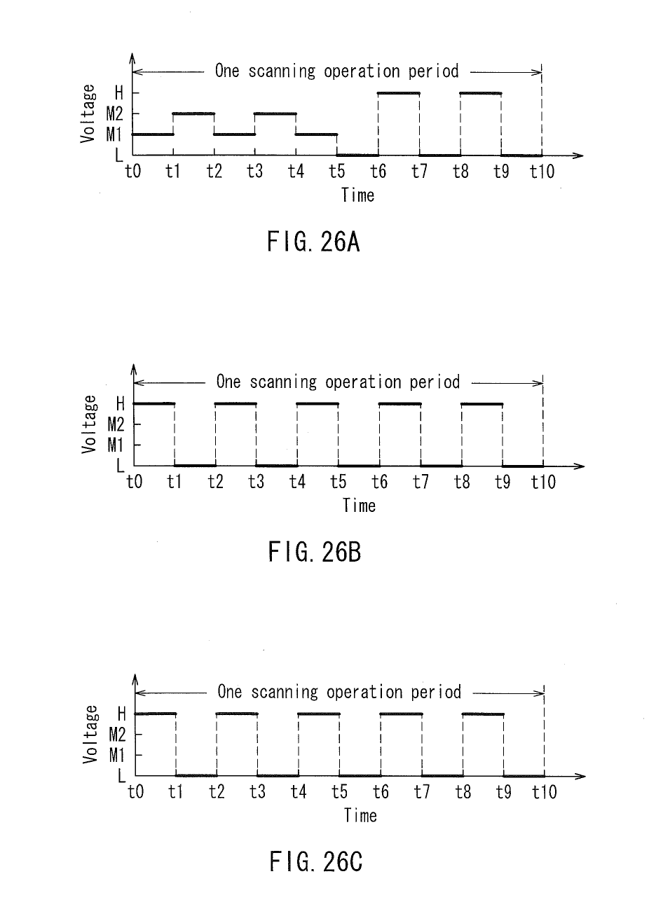

FIG. 25 is a block diagram showing the specific configuration of a display control portion of a display element of Embodiment 6. FIGS. 26A, 26B, and 26C are diagrams showing an example of the application of a voltage to a pixel electrode, a first common electrode, and a second common electrode of the display element of Embodiment 6 during halftone display, respectively.

In FIGS. 25 and 26, this embodiment mainly differs from Embodiment 5 in that the display control portion allows the polarities of the signal voltage and the first and second common voltages to be switched at intervals of a predetermined time which is shorter than one scanning operation period. The same components as those of Embodiment 5 are denoted by the same reference numerals, and the explanation will not be repeated.

In FIG. 25, similarly to Embodiment 5, the display element 2 of this embodiment includes a display control portion 31 that includes an image processing portion 31a and a frame buffer 31b. However, unlike Embodiment 5, the display control portion 31 outputs the instruction signals to the signal driver 4 and the first and second common drivers 6, 7 so that the polarities of the signal voltage and the first and second common voltages are switched at intervals of a predetermined time which is shorter than the scanning operation period (refresh period). In the display element 2 of this embodiment, similarly to Embodiment 5, the signal driver 4 applies one of the maximum voltage (H voltage), the minimum voltage (L voltage), and the arbitrary voltage between the maximum voltage and the minimum voltage in the predetermined voltage range as the signal voltage.

When the image display apparatus 1 of this embodiment displays halftones in the gradation display, similarly to Embodiment 5, the display control portion 31 determines the application time of the maximum voltage, the application time of the arbitrary voltage, and the application time of the minimum voltage in one scanning operation period for each of the pixel regions P based on the external image input signal, and then indicates the determined application times to the signal driver 4. Moreover, the display control portion 31 of this embodiment determines the application time of the maximum voltage, the application time of the arbitrary voltage, and the application time of the minimum voltage in view of the predetermined interval (i.e., the period of time in which the polarities of the signal voltage and the first and second common voltages are switched).

Specifically, e.g., when the gradation value for any one of the pixel regions P is “68”, based on this gradation value (“68”) and in view of the fact that the polarities are switched at intervals of one-tenth of the one scanning operation period, the display control portion 31 determines that the signal voltage is 6 V while the H voltage (18 V) is being applied to the first and second common electrodes 13, 14, and that a signal voltage (6 V) application time is three-tenths of the one scanning operation period. Moreover, the display control portion 31 determines that the signal voltage is 12 V while the L voltage (0 V) is being applied to the first and second common electrodes 13, 14, and that a signal voltage (12 V) application time is two-tenths of the one scanning operation period. Further, the display control portion 31 determines that the H voltage or the L voltage that is the same as the voltage to be applied to the first and second common electrodes 13, 14 is applied as the signal voltage for the remainder of the one scanning operation period so as to prevent the polar liquid 21 from moving. The display control portion 31 outputs the instruction signal to the signal driver 4 so that signal voltages of 6 V, 12 V, 18 V, and 0 V are applied to the pixel electrode 12 of this pixel regions P at predetermined intervals.

Thus, as shown in FIG. 26A, the M1 voltage (6 V) is applied from the signal electrode 10 to the pixel electrode 12 in any one of the pixel regions P for the period from a time t0 to a time t1. Then, the M2 voltage (12 V) is applied to the pixel electrode 12 for the period from the time t1 to a time t2, followed by the M1 voltage for the period from the time t2 to a time t3. Subsequently, the M2 voltage is applied to the pixel electrode 12 for the period from the time t3 to a time t4, followed by the M1 voltage for the period from the time t4 to a time t5. Subsequently, the L voltage is applied to the pixel electrode 12 for the period from the time t5 to a time t6, followed by the H voltage for the period from the time t6 to a time t7. Subsequently, the L voltage is applied to the pixel electrode 12 for the period from the time t7 to a time t8, followed by the H voltage for the period from the time t8 to a time t9. Thereafter, the L voltage is applied to the pixel electrode 12 for the period from the time t9 to a time t10.

The image processing portion 31a of the display control portion 31 outputs the instruction signal to the first common driver 6 so that the polarities of the first common voltage are switched at intervals of one-tenth of the one scanning operation period. Thus, as shown in FIG. 26B, the H voltage is applied to the first common electrode 13 for the period from a time t0 to a time t1. Then, the L voltage is applied to the first common electrode 13 for the period from the time t1 to a time t2, followed by the H voltage for the period from the time t2 to a time t3. Subsequently, the L voltage is applied to the first common electrode 13 for the period from the time t3 to a time t4, followed by the H voltage for the period from the time t4 to a time t5. Subsequently, the L voltage is applied to the first common electrode 13 for the period from the time t5 to a time t6, followed by the H voltage for the period from the time t6 to a time t7. Subsequently, the L voltage is applied to the first common electrode 13 for the period from the time t7 to a time t8, followed by the H voltage for the period from the time t8 to a time t9. Thereafter, the L voltage is applied to the first common electrode 13 for the period from the time t9 to a time t10.

The image processing portion 31a of the display control portion 31 outputs the instruction signal to the second common driver 7 so that the polarities of the second common voltage are switched at intervals of one-tenth of the one scanning operation period. Thus, as shown in FIG. 26C, the H voltage is applied to the second common electrode 14 for the period from a time t0 to a time t1. Then, the L voltage is applied to the second common electrode 14 for the period from the time t1 to a time t2, followed by the H voltage for the period from the time t2 to a time t3. Subsequently, the L voltage is applied to the second common electrode 14 for the period from the time t3 to a time t4, followed by the H voltage for the period from the time t4 to a time t5. Subsequently, the L voltage is applied to the second common electrode 14 for the period from the time t5 to a time t6, followed by the H voltage for the period from the time t6 to a time t7. Subsequently, the L voltage is applied to the second common electrode 14 for the period from the time t7 to a time t8, followed by the H voltage for the period from the time t8 to a time t9. Thereafter, the L voltage is applied to the second common electrode 14 for the period from the time t9 to a time t10.

Due to the above voltage application, the halftone display with a gradation value of “68” is performed. For three-tenths of the one scanning operation period, the voltage is applied to make a potential difference of 12 V (=18 V−6 V) between the pixel electrode 12 and the second common electrode 14. For two-tenths of the one scanning operation period, the voltage is applied to make a potential difference of 6 V (=18 V−12 V) between the pixel electrode 12 and the second common electrode 14. For the remaining one-half of the one scanning operation period (i.e., the period from the time t5 to the time t10), the voltage is applied to make a potential difference of 0 V between the pixel electrode 12 and the second common electrode 14. Consequently, the polar liquid 21 is moved toward the pixel electrode 12 (the non-effective display region P2) by a distance that is 0.27 (=12/18×3/10+6/18×2/10) times, and thus the gradation display is performed according to the gradation value “68” (which is 0.27 times the 256 gray levels) in this pixel region P.

In the above description, the predetermined interval is the period of time that is one-tenth of the one scanning operation period. However, this embodiment is not limited thereto, as long as the application time of the H voltage and the application time of the L voltage are determined according to the gradation value, and the H voltage and the L voltage are applied alternately. Specifically, in this embodiment, e.g., when the gradation display with a gradation value of “n” (e.g., n is an integer of 0 to 255) is performed, provided that the predetermined interval is period of time that is obtained by multiplying the one scanning operation period by 1/256, the application time of the H voltage may be n/256×one scanning operation period, and the application time of the L voltage may be the remainder of the one scanning operation period.

With the above configuration, this embodiment can have the same effects as those of Embodiment 5. In this embodiment, the display control portion 31 instructs the signal driver 4 and the first and second common drivers 6, 7 to switch the polarities of the signal voltage and the first and second common voltages at predetermined intervals, respectively. Thus, this embodiment can prevent uneven distribution of the polarities in each of the signal electrodes 10, the pixel electrodes 12, and the first and second common electrodes 13, 14, and can easily stabilize the behavior of the polar liquid 21.

In this embodiment, the display control portion 31 indicates that the predetermined interval is the period of time that is shorter than the one scanning operation period. Thus, this embodiment can further prevent uneven distribution of the polarities in each of the signal electrodes 10, the pixel electrodes 12, and the first and second common electrodes 13, 14, and can more easily stabilize the behavior of the polar liquid 21.

The above embodiments are all illustrative and not restrictive. The technical scope of the present invention is defined by the appended claims, and all changes that come within the range of equivalency of the claims are intended to be embraced therein.

For example, in the above description, the present invention is applied to an image display apparatus including a display portion. However, the present invention is not limited thereto, and may be applied to an electrical device with a display portion that displays the information including characters and images. For example, the present invention is suitable for various electrical devices with display portions such as a personal digital assistant such as an electronic organizer, a display apparatus for a personal computer or television, and an electronic paper.

In the above description, the electrowetting type display element is used, in which the polar liquid is moved in accordance with the application of an electric field to the polar liquid. However, the display element of the present invention is not limited thereto, and may be an electric-field-induced display element that can change the display color on the display surface side by moving the polar liquid in the display space with the use of an external electric field. For example, the present invention can be applied to other types of electric-field-induced display elements such as an electroosmotic type, an electrophoretic type, and a dielectrophoretic type.

As described in each of the above embodiments, the electrowetting type display element is preferred because the polar liquid can be moved at a high speed and a low drive voltage. In the electrowetting type display element, the display color is changed with the movement of the polar liquid. Therefore, unlike a liquid crystal display apparatus or the like using a birefringent material such as a liquid crystal layer, it is possible to easily provide a high-intensity display element with excellent utilization efficiency of light from the backlight or ambient light used for information display.

The above description refers to the transmission type display element including a backlight. However, the present invention is not limited thereto, and may be applied to a reflection type display element including a light reflection portion such as a diffuse reflection plate, or a semi-transmission type display element including the light reflection portion and a backlight.

In the above description, the polar liquid is a potassium chloride aqueous solution. However, the polar liquid of the present invention is not limited thereto. Specifically, the polar liquid can be, e.g., a material containing an electrolyte such as zinc chloride, potassium hydroxide, sodium hydroxide, alkali metal hydroxide, zinc oxide, sodium chloride, lithium salt, phosphoric acid, alkali metal carbonate, or ceramics with oxygen ion conductivity. The solvent can be, e.g., an organic solvent such as alcohol, acetone, formamide, or ethylene glycol other than water. The polar liquid of the present invention also can be an ionic liquid (room temperature molten salt) including pyridine-, alicyclic amine-, or aliphatic amine-based cations and fluorine anions such as fluoride ions or triflate.

The polar liquid of the present invention includes a conductive liquid and a high dielectric liquid having a relative dielectric constant of a predetermined value or more, and preferably 15 or more.

As described in each of the above embodiments, the aqueous solution in which a predetermined electrolyte is dissolved is preferred for the polar liquid because the aqueous solution can enhance ease of handling, and also can easily constitute a display element that is easy to manufacture.

In the above description, the nonpolar oil is used. However, the present invention is not limited thereto, and an insulating fluid that is not mixed with the polar liquid may be used. For example, air may be used instead of the oil. Moreover, silicone oil or an aliphatic hydrocarbon also can be used as the oil. The insulating fluid of the present invention includes a fluid having a relative dielectric constant of a predetermined value or less, and preferably 5 or less.

As described in each of the above embodiments, the nonpolar oil that is not compatible with the polar liquid is preferred because droplets of the polar liquid move more easily in the nonpolar oil compared to the use of air and the polar liquid. Consequently, the polar liquid can be moved at a high speed, and the display color can be switched at a high speed.

In the above description, the scanning electrodes, the signal electrodes, the switching elements, the pixel electrodes, and the first common electrodes are provided on the upper substrate (first substrate), and the second common electrodes are provided on the lower substrate (second substrate). However, in the present invention, the second common electrodes may be placed in the display space so as to be in contact with the polar liquid, and the scanning electrodes, the signal electrodes, the pixel electrodes, and the first common electrode may be provided on one of the first substrate and the second substrate so as to be electrically insulated from the polar liquid and each other. Specifically, e.g., the second common electrodes may be provided in the intermediate portion between the first substrate and the second substrate, and the scanning electrodes, the signal electrodes, the pixel electrodes, the first common electrodes, and the switching elements may be provided on the second substrate.

In the above description, the first common electrodes and the pixel electrodes are located on the effective display region side and the non-effective display region side, respectively. However, the present invention is not limited thereto, and the first common electrodes and the pixel electrodes may be located on the non-effective display region side and the effective display region side, respectively.

In the above description, the first common electrodes and the pixel electrodes are formed on the surface of the upper substrate (first substrate) that faces the display surface side. However, the present invention is not limited thereto, and the first common electrodes and the pixel electrodes may be buried in the first substrate made of an insulating material. In this case, the first substrate also can serve as a dielectric layer, which can eliminate the formation of the dielectric layer. Moreover, the second common electrodes may be directly provided on the first or second substrate serving as a dielectric layer, and thus may be placed in the display space.

In the above description, the first common electrodes and the pixel electrodes are made of a transparent electrode material. However, in the present invention, either the first common electrodes or the pixel electrodes that face the effective display region in each of the pixels may be made of the transparent electrode material. The other of the first common electrodes and the pixel electrodes that do not face the effective display region may be made of an opaque electrode material such as aluminum, silver, chromium, or other metals.

In the above description, the first common electrodes and the pixel electrodes are arranged in stripes. However, the shapes of the first common electrodes and the pixel electrodes of the present invention are not limited thereto. For example, the reflection type display element may use linear or network electrodes, which are not likely to cause an optical loss, since the utilization efficiency of light used for information display is lower in the reflection type display element than in the transmission type display element.

In the above description, the second common electrodes are linear wires. However, the second common electrodes of the present invention are not limited thereto, and can be wires with other shapes such as network wires.

In the above description, a thin film transistor is used as the switching element. However, the switching element of the present invention is not limited thereto, and can be, e.g., a field-effect transistor.

In the above description, the black colored polar liquid and the color filter layer are used to form the pixels of R, G, and B colors on the display surface side. However, the present invention is not limited thereto, and a plurality of pixel regions may be provided in accordance with a plurality of colors that enable full-color display to be shown on the display surface. Specifically, the polar liquids that are colored different colors such as RGB, CMY composed of cyan (C), magenta (M), and yellow (Y), or RGBYC also can be used.

In the above description, the color filter layer is formed on the surface of the upper substrate (first substrate) that faces the non-display surface side. However, the present invention is not limited thereto, and the color filter layer may be formed on the surface of the first substrate that faces the display surface side or on the lower substrate (second substrate). Thus, the color filter layer is preferred compared to the use of polar liquids with different colors because the color filter layer can easily constitute a display element that is easy to manufacture. Moreover, the color filter layer is also preferred because the effective display region and the non-effective display region can be properly and reliably defined with respect to the display space by the color filter (aperture) and the black matrix (light-shielding film) included in the color filter layer, respectively.

### INDUSTRIAL APPLICABILITY

The present invention is useful for a display element that can easily improve the speed of information display, and an electrical device using the display element.

### DESCRIPTION OF REFERENCE NUMERALS

1 Image display apparatus (electrical device)
2 Display element
3, 27, 28, 29, 30, 31 Display control portion
4 Signal driver (signal voltage application portion)
5 Scanning driver (scanning voltage application portion)
6 First common driver (first common voltage application portion)
7 Second common driver (second common voltage application portion)
8 Upper substrate (first substrate)
9 Lower substrate (second substrate)
10 Signal electrode
11 Scanning electrode
12 Pixel electrode
13 First common electrode
14, 14′ Second common electrode
19 Color filter layer
19r, 19g, 19b Color filter (aperture)
19s Black matrix (light-shielding film)
20a First rib
20a1, 20a2 First rib member
20b Second rib
20b1, 20b2 Second rib member
21 Polar liquid
22 Oil (insulating fluid)
23 Dielectric layer
SW Thin film transistor (switching element)
S Display space
P Pixel region
P1 Effective display region
P2 Non-effective display region

1. A display element that comprises a first substrate provided on a display surface side, a second substrate provided on a non-display surface side of the first substrate so that a predetermined display space is formed between the first substrate and the second substrate, an effective display region and a non-effective display region that are defined with respect to the display space, and a polar liquid sealed in the display space so as to be moved toward the effective display region or the non-effective display region, and that is capable of changing a display color on the display surface side by moving the polar liquid,
wherein the display element comprises:
a plurality of scanning electrodes that are provided on one of the first substrate and the second substrate so as to be electrically insulated from the polar liquid;
a plurality of signal electrodes that are provided on one of the first substrate and the second substrate so as to be electrically insulated from the polar liquid and the plurality of the scanning electrodes, and are also arranged so as to intersect with the plurality of the scanning electrodes;
a plurality of pixel regions that are located at each of the intersections of the plurality of the scanning electrodes and the plurality of the signal electrodes;
ribs that are provided so as to divide the inside of the display space in accordance with the plurality of the pixel regions;
a plurality of switching elements that are provided for each of the plurality of the pixel regions and connected to the plurality of the scanning electrodes and the plurality of the signal electrodes, respectively;
a plurality of pixel electrodes that are provided on one of the first substrate and the second substrate so as to be electrically insulated from the polar liquid, the plurality of the scanning electrodes, and the plurality of the signal electrodes and to be located on one of the effective display region side and the non-effective display region side, and that are also connected to the plurality of the switching elements, respectively;
a plurality of first common electrodes that are provided on one of the first substrate and the second substrate so as to be electrically insulated from the polar liquid, the plurality of the scanning electrodes, the plurality of the signal electrodes, and the plurality of the pixel electrodes and to be located on the other of the effective display region side and the non-effective display region side, and that are also arranged so as to intersect with the plurality of the scanning electrodes; and
a second common electrode that is placed in the display space so as to be in contact with the polar liquid.

2. The display element according to claim 1, comprising:
a display control portion that performs drive control of each of the plurality of the scanning electrodes, the plurality of the signal electrodes, the plurality of the first common electrodes, and the second common electrodes so that a scanning operation is performed along a predetermined scanning direction based on an external image input signal;
a signal voltage application portion that is connected to the plurality of the signal electrodes and the display control portion, and applies a signal voltage in a predetermined voltage range to each of the plurality of the signal electrodes in accordance with information to be displayed on the display surface side based on an instruction signal from the display control portion;
a scanning voltage application portion that is connected to the plurality of the scanning electrodes and the display control portion, and applies one of an ON-state voltage and an OFF-state voltage as a scanning voltage to each of the plurality of the scanning electrodes, the ON-state voltage turning the switching elements on and allowing the signal voltage to be applied to the pixel electrodes connected to the switching elements that have been turned on, and the OFF-state voltage turning the switching elements off;
a first common voltage application portion that is connected to the plurality of the first common electrodes and the display control portion, and applies a first common voltage in a predetermined voltage range, including an allowable voltage that allows the polar liquid to move in the display space in response to the signal voltage applied to the pixel electrodes, to each of the plurality of the first common electrodes; and
a second common voltage application portion that is connected to the second common electrode and the display control portion, and applies a second common voltage in a predetermined voltage range, including an allowable voltage that allows the polar liquid to move in the display space in response to the signal voltage applied to the pixel electrodes, to the second common electrode.

3. The display element according to claim 2, wherein when gradation display is performed for each of the plurality of the pixel regions on the display surface side, the display control portion determines a value of the signal voltage in one scanning operation period for each of the plurality of the pixel regions based on the gradation display, and indicates the determined signal voltage value to the signal voltage application portion.

4. The display element according to claim 2, wherein the signal voltage application portion is configured to apply one of a maximum voltage and a minimum voltage in the predetermined voltage range as the signal voltage, and
when gradation display is performed for each of the plurality of the pixel regions on the display surface side, the display control portion determines an application time of the maximum voltage and an application time of the minimum voltage in one scanning operation period for each of the plurality of the pixel regions based on the gradation display, and indicates the determined application times to the signal voltage application portion.

5. The display element according to claim 2, wherein the signal voltage application portion is configured to apply one of a maximum voltage, a minimum voltage, and an arbitrary voltage between the maximum voltage and the minimum voltage in the predetermined voltage range as the signal voltage, and
when gradation display is performed for each of the plurality of the pixel regions on the display surface side, the display control portion determines an application time of the maximum voltage, an application time of the arbitrary voltage, and an application time of the minimum voltage in one scanning operation period for each of the plurality of the pixel regions based on the gradation display, and indicates the determined application times to the signal voltage application portion.

6. The display element according to claim 2, wherein the display control portion instructs the signal voltage application portion and the first and second common voltage application portions to switch polarities of the corresponding signal voltage and first and second common voltages at predetermined intervals.

7. The display element according to claim 6, wherein the display control portion indicates that the predetermined interval is a period of time that is shorter than one scanning operation period.

8. The display element according to claim 2, wherein the display control portion outputs instruction signals to the signal voltage application portion, the scanning voltage application portion, and the first and second common voltage application portions so that a refresh operation is performed every time display of information per 1 frame is finished in order to move the polar liquid in all the plurality of the pixel regions to an initial position located on the effective display region side or the non-effective display region side.

9. The display element according to claim 1, wherein the plurality of the pixel regions are provided in accordance with a plurality of colors that enable full-color display to be shown on the display surface side.

10. The display element according to claim 1, wherein a dielectric layer is formed on surfaces of the plurality of the pixel electrodes and the plurality of the first common electrodes.

11. The display element according to claim 1, wherein an insulating fluid that is not mixed with the polar liquid is movably sealed in the display space.

12. The display element according to claim 1, wherein the non-effective display region is defined by a light-shielding film that is provided on one of the first substrate and the second substrate, and
the effective display region is defined by an aperture formed in the light-shielding film.

13. An electrical device comprising a display portion that displays information including characters and images,
wherein the display portion comprises the display element according to claim 1.
